(19) United States
(12) Patent Application Publication
(10) Pub. No.: US 2025/0355143 A1
(43) Pub. Date: Nov. 20, 2025

(54) LIQUID CRYSTAL DIFFRACTION ELEMENT AND OPTICAL DEVICE

(71) Applicant: FUJIFILM Corporation, Tokyo (JP)

(72) Inventors: Hiroshi SATO, Minamiashigara-shi (JP); Takashi YONEMOTO, Minamiashigara-shi (JP); Takeharu TANI, Minamiashigara-shi (JP)

(73) Assignee: FUJIFILM Corporation, Tokyo (JP)

(21) Appl. No.: 19/286,350

(22) Filed: Jul. 31, 2025

Related U.S. Application Data
(63) Continuation of application No. PCT/JP2024/008041, filed on Mar. 4, 2024.

(30) Foreign Application Priority Data
Mar. 14, 2023 (JP) 2023-039509
Nov. 29, 2023 (JP) 2023-201450

(51) Int. Cl. G02B 3/12; G02B 27/01

(52) U.S. Cl. CPC G02B 3/12; G02B 27/0172; G02B 2027/0174

(57) ABSTRACT

An object is to provide a liquid crystal diffraction element having excellent diffraction efficiency and an optical device including the liquid crystal diffraction element. The object is achieved by a liquid crystal diffraction element including an optically-anisotropic layer containing a liquid crystal compound, in which the optically-anisotropic layer has a liquid crystal alignment pattern in which an orientation of an optical axis derived from the liquid crystal compound changes while continuously rotating in at least one in-plane direction, a region where the liquid crystal compound has a tilt angle is provided, and a region where the tilt angle varies in a plane is provided.

### CROSS-REFERENCE TO RELATED APPLICATIONS

This application is a Continuation of PCT International Application No. PCT/JP2024/008041, filed on Mar. 4, 2024, which claims priority under 35 U.S.C. § 119(a) to Japanese Patent Application No. 2023-039509, filed on Mar. 14, 2023, and Japanese Patent Application No. 2023-201450, filed on Nov. 29, 2023. The above applications are hereby expressly incorporated by reference, in their entirety, into the present application.

### BACKGROUND OF THE INVENTION

### 1. Field of the Invention

The present invention relates to a liquid crystal diffraction element used in a head mounted display or the like, and an optical device including the liquid crystal diffraction element.

### 2. Description of the Related Art

As a unit which delivers virtual reality (VR) to an observer, a head mounted display (HMD) or the like has been proposed. A head mounted display which is relatively small and easy to carry and wear has been expected as a multifunctional device which replaces a smartphone, a tablet, and the like.

As a head mounted display which is capable of binocular viewing, has excellent reproduction of a stereoscopic effect, and can be realized with a relatively simple configuration, a head mounted display using a magnifying optical system with a lens has been realized. In particular, in a high-end model, a high-resolution display element and a laminated lens are combined to realize a user experience which has never been realized before.

However, in a case where a laminated lens utilized in a camera, a binocle, or the like is used as the lens, aberration, distortion, and the like are small, and a natural image can be provided to a user; but the weight and the bulk are large, and thus the physical burden on the user is large.

On the other hand, by using a lens (liquid crystal lens) based on a liquid crystal diffraction element, it is possible to reduce the size and thickness of the optical system in the head mounted display and to reduce the weight.

As the liquid crystal lens, for example, a liquid crystal lens (liquid crystal diffractive lens) shown in FIG. 2B of JP2016-519327A has been known.

The liquid crystal lens has a concentric circular liquid crystal alignment pattern in which an orientation of an optical axis derived from a liquid crystal compound changes while continuously rotating in at least one in-plane direction, and has an optically-anisotropic layer (liquid crystal layer) in which the liquid crystal compound is immobilized.

### SUMMARY OF THE INVENTION

In the liquid crystal alignment pattern of the liquid crystal lens, in a case where a length over which the orientation of the optical axis derived from the liquid crystal compound rotates by 180° in a plane is set as a single period, as the single period decreases, a diffraction angle of light increases.

Therefore, the liquid crystal lens has a liquid crystal alignment pattern in which the single period gradually decreases from the center toward the outer direction.

Here, in order to further reduce the size and thickness of the optical system in the head mounted display, it is necessary to shorten a focal length of the liquid crystal lens. That is, in order to further reduce the size and thickness of the optical system in the head mounted display, it is necessary to further reduce the single period of the liquid crystal lens.

However, in a case where the single period of the liquid crystal lens is reduced, there is a problem in that diffraction efficiency is lowered. In particular, in a case where the length of the single period is shortened to the level of 1 m, the diffraction efficiency is deteriorated in a high diffraction angle region outside the liquid crystal lens, and sufficient diffraction efficiency cannot be obtained.

An object of the present invention is to solve such a problem in the related art, and to provide a liquid crystal diffraction element used in a liquid crystal lens or the like, in which, even in a case where a single period in a liquid crystal alignment pattern is reduced, excellent diffraction efficiency can be obtained, and to provide an optical device including the liquid crystal diffraction element.

In order to solve the problems, the present invention has the following configuration.

[1] A liquid crystal diffraction element comprising:
an optically-anisotropic layer formed of a liquid crystal composition containing a liquid crystal compound;
in which the optically-anisotropic layer has a liquid crystal alignment pattern in which an orientation of an optical axis derived from the liquid crystal compound changes while continuously rotating in at least one in-plane direction,
on at least one surface of the optically-anisotropic layer, a region where the liquid crystal compound has a tilt angle with respect to the surface of the optically-anisotropic layer is provided, and
in a plane of the optically-anisotropic layer, a region where the tilt angle of the liquid crystal compound with respect to the surface of the optically-anisotropic layer varies is provided.

[2] A liquid crystal diffraction element comprising:
an optically-anisotropic layer formed of a liquid crystal composition containing a liquid crystal compound;
in which the optically-anisotropic layer has a liquid crystal alignment pattern in which an orientation of an optical axis derived from the liquid crystal compound changes while continuously rotating in at least one in-plane direction,
in a case where a retardation is measured from a normal direction of a main surface of the optically-anisotropic layer and from a direction inclined with respect to a normal line, in the optically-anisotropic layer, a region where a direction in which the retardation reaches an extreme value is inclined with respect to the normal direction is provided, and
in a plane of the optically-anisotropic layer, a region where an angle of the optically-anisotropic layer in which the retardation reaches an extreme value varies is provided.

[3] The liquid crystal diffraction element according to [1] or [2],
in which, in a case where a length over which the orientation of the optical axis derived from the liquid crystal compound rotates by 180° in a plane is set as a single period, a region where the length of the single period in the liquid crystal alignment pattern varies in the plane is provided.

[4] The liquid crystal diffraction element according to [3],
in which the length of the single period in the liquid crystal alignment pattern gradually changes in the one direction, and
the tilt angle of the liquid crystal compound gradually changes in the one direction.

[5] The liquid crystal diffraction element according to [3] or [4],
in which the tilt angle of the liquid crystal compound increases as the length of the single period in the liquid crystal alignment pattern decreases.

[6] The liquid crystal diffraction element according to any one of [1] to [5],
in which, in a cross-sectional image obtained by observing a cross section of the optically-anisotropic layer in a thickness direction along the one direction with a scanning electron microscope, the optically-anisotropic layer has a bright portion and a dark portion, extending from one surface to the other surface, and
in the thickness direction, a region where an inclination angle of the dark portion is different from the tilt angle of the liquid crystal compound is provided.

[7] The liquid crystal diffraction element according to [6],
in which a plurality of the optically-anisotropic layers having different inclination angles of the dark portions are provided.

[8] An optical device comprising:
the liquid crystal diffraction element according to any one of [1] to [7]; and
a light source which causes light to be incident into the liquid crystal diffraction element,
in which, in a case where an emission angle of a first-order light emitted from the liquid crystal diffraction element is indicated by θm and a refractive index of the optically-anisotropic layer is indicated by nG, a tilt angle θP of the liquid crystal compound is within a range of θG±15© with regard to an angle θG calculated by the following expression,

Sin θG=Sin θm/nG

[9] An optical device comprising:
the liquid crystal diffraction element according to any one of [2] to [7]; and
a light source which causes light to be incident into the liquid crystal diffraction element,
in which, in a case where an emission angle of a first-order light emitted from the liquid crystal diffraction element is indicated by θm and a refractive index of the optically-anisotropic layer is indicated by nG, an angle θP between the direction of the optically-anisotropic layer in which the retardation reaches an extreme value and the normal direction of the main surface of the optically-anisotropic layer is within a range of θG±15° with regard to an angle θG calculated by the following expression,

Sin θG=Sin θm/nG

According to the present invention, in a liquid crystal diffraction element used in a liquid crystal lens or the like, even in a case where a single period in a liquid crystal alignment pattern is reduced, excellent diffraction efficiency can be obtained.

### BRIEF DESCRIPTION OF THE DRAWINGS

FIG. 1 is a plan view conceptually showing an example of the liquid crystal diffraction element according to the embodiment of the present invention.

FIG. 2 is a view conceptually showing a cross section of the liquid crystal diffraction element shown in FIG. 1.

FIG. 3 is a conceptual view showing the liquid crystal diffraction element according to the embodiment of the present invention.

FIG. 4 is a conceptual view showing an example of an optically-anisotropic layer.

FIG. 5 is a conceptual view showing another example of the optically-anisotropic layer.

FIG. 6 is a conceptual view showing the liquid crystal diffraction element according to the embodiment of the present invention.

FIG. 7 is a conceptual view showing the action of the liquid crystal diffraction element according to the embodiment of the present invention.

FIG. 8 is a conceptual view showing the action of the liquid crystal diffraction element according to the embodiment of the present invention.

FIG. 9 is a view conceptually showing another example of the liquid crystal diffraction element according to the embodiment of the present invention.

FIG. 10 is a view conceptually showing another example of the liquid crystal diffraction element according to the embodiment of the present invention.

FIG. 11 is a view conceptually showing another example of the liquid crystal diffraction element according to the embodiment of the present invention.

FIG. 12 is a view conceptually showing another example of the liquid crystal diffraction element according to the embodiment of the present invention.

FIG. 13 is a conceptual view showing the liquid crystal diffraction element according to the embodiment of the present invention.

FIG. 14 is a conceptual view showing the liquid crystal diffraction element according to the embodiment of the present invention.

FIG. 15 is a view conceptually showing another example of the liquid crystal diffraction element according to the embodiment of the present invention.

FIG. 16 is a view conceptually showing another example of the liquid crystal diffraction element according to the embodiment of the present invention.

FIG. 17 is a view conceptually showing another example of the liquid crystal diffraction element according to the embodiment of the present invention.

FIG. 18 is a view conceptually showing an exposure device for producing the liquid crystal diffraction element according to the embodiment of the present invention.

### DESCRIPTION OF THE PREFERRED EMBODIMENTS

Hereinafter, the liquid crystal diffraction element and the optical device according to the embodiments of the present invention will be described in detail based on suitable examples shown in the accompanying drawings.

Although configuration requirements to be described below are described based on representative embodiments of the present invention, the present invention is not limited to the embodiments.

In addition, all of the drawings described below are conceptual diagrams for explaining the present invention, and the shape, size, thickness, positional relationship, and the like of each member do not necessarily match those of real objects.

Any numerical range expressed using “to” in the present specification refers to a range including the numerical values before and after the “to” as a lower limit value and an upper limit value, respectively.

### First Embodiment

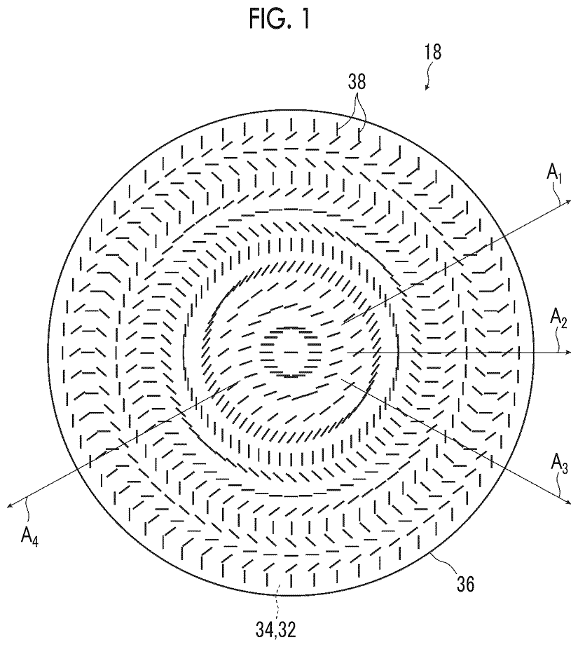

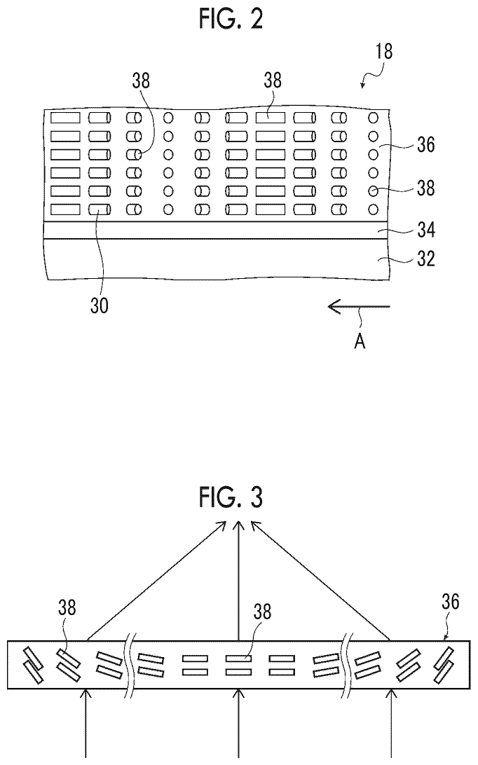

FIGS. 1 and 2 conceptually show an example (first embodiment) of the liquid crystal diffraction element according to the present invention. FIG. 1 is a plan view, and FIG. 2 is a cross-sectional view in a thickness direction. The liquid crystal diffraction element is used as a liquid crystal lens (liquid crystal diffractive lens).

As shown in FIGS. 1 and 2, a liquid crystal diffraction element 18 includes a substrate 32, an alignment film 34, and an optically-anisotropic layer 36. In the liquid crystal diffraction element 18, the optically-anisotropic layer 36 acts as a liquid crystal diffraction element (liquid crystal lens).

Accordingly, the liquid crystal diffraction element 18 may be configured with only the optically-anisotropic layer 36 by peeling off the substrate 32 and the alignment film 34. Alternatively, the liquid crystal diffraction element 18 may be configured with the alignment film 34 and the optically-anisotropic layer 36 by peeling off the substrate 32. Alternatively, the liquid crystal diffraction element 18 may be a laminate in which, after peeling the substrate 32 and the alignment film 34 from the optically-anisotropic layer 36, the optically-anisotropic layer 36 is laminated on another substrate.

In the liquid crystal diffraction element 18 shown in FIGS. 1 and 2, the optically-anisotropic layer 36 is a liquid crystal layer which is formed on the alignment film 34 using a composition containing a liquid crystal compound 38, in which the liquid crystal compound 38 is aligned and immobilized in the following liquid crystal alignment pattern.

Specifically, the optically-anisotropic layer 36 has a liquid crystal alignment pattern in which an orientation of an optical axis derived from the liquid crystal compound 38 changes while continuously rotating in one direction in a radial shape from an inner side toward an outer side. That is, the liquid crystal alignment pattern in the optically-anisotropic layer 36 shown in FIGS. 1 and 2 is a concentric pattern including the one direction in which the orientation of the optical axis derived from the liquid crystal compound 38 changes while continuously rotating in a concentric circular shape from the inner side toward the outer side.

In FIGS. 1 and 2, for example, a rod-like liquid crystal compound is exemplified as the liquid crystal compound 38, so that the direction of the optical axis matches with a longitudinal direction of the liquid crystal compound 38.

More specifically, in the optically-anisotropic layer 36, the orientation of the optical axis of the liquid crystal compound 38 changes while continuously rotating in a plurality of directions radially outward from the center of the optically-anisotropic layer 36, that is, the optical axis of the liquid crystal lens; for example, a direction indicated by an arrow A₁, a direction indicated by an arrow A₂, a direction indicated by an arrow A₃, a direction indicated by an arrow A₄, and so on.

In the optically-anisotropic layer 36, a rotation direction of the optical axes of the liquid crystal compounds 38 is identical in all directions (one direction). In the example shown in the drawing, the rotation direction of the optical axes of the liquid crystal compounds 38 is counterclockwise, in all the directions including the direction indicated by the arrow A₁, the direction indicated by the arrow A₂, the direction indicated by the arrow A₃, and the direction indicated by the arrow A₄.

That is, in a case where the arrow A₁ and the arrow A₄ are assumed as one straight line, the rotation direction of the optical axes of the liquid crystal compounds 38 is reversed at the center of the optically-anisotropic layer 36 on the straight line. For example, the straight line formed by the arrow A₁ and the arrow A₄ is directed in the right direction (arrow A₁ direction) in the drawing. In this case, the optical axis of the liquid crystal compound 38 initially rotates clockwise from the outer side to the center of the optically-anisotropic layer 36, the rotation direction is reversed at the center of the optically-anisotropic layer 36, and then the optical axis of the liquid crystal compound 36 rotates counterclockwise from the center to the outer side of the optically-anisotropic layer 36. The center of the optically-anisotropic layer 36 is the optical axis of the liquid crystal lens.

In addition, in FIG. 2, in order to clarify the configuration of the optically-anisotropic layer 36, the liquid crystal compound 38 is shown to be parallel to a surface of the optically-anisotropic layer 36.

However, in the liquid crystal diffraction element 18 which is the liquid crystal diffraction element according to the embodiment of the present invention, on at least one surface of the optically-anisotropic layer 36, the liquid crystal compound 38 has a region having a tilt angle with respect to the surface of the optically-anisotropic layer 36, that is, the main surface. The main surface is the maximum surface of a layer (sheet-like material, membrane, or film), and is usually both surfaces in the thickness direction.

In the liquid crystal diffraction element 18 in the example shown in the drawing, as conceptually shown in FIG. 3, in a center region of the concentric circle, the liquid crystal compound 38 is aligned in parallel with both surfaces of the optically-anisotropic layer 36. On the other hand, in a region away from the center of the concentric circle, the liquid crystal compound 38 is in a state of being aligned with a tilt angle with respect to both surfaces of the optically-anisotropic layer 36, that is, in a state of being tilt-aligned. In the example shown in the drawing, the liquid crystal compound 38 has a tilt angle such that the liquid crystal compound 38 rises from the outer side toward the inner side with respect to the center of the concentric circle.

In addition, as conceptually shown in FIG. 3, in the liquid crystal diffraction element 18 in the example shown in the drawing, as a preferred example, the tilt angle of the liquid crystal compound 38 gradually increases from the inner side toward the outer side of the concentric circle. That is, in the liquid crystal diffraction element 18, the tilt angle of the liquid crystal compound 38 gradually increases from the center toward the outer side of the concentric circle.

Although described later, the optically-anisotropic layer 36 has a liquid crystal alignment pattern in which, in a case where a length over which the orientation of the optical axis derived from the liquid crystal compound in the liquid crystal alignment pattern rotates by 1800 is set as a single period, the single period gradually decreases from the inner side toward the outer side of the concentric circle.

As described above, the tilt angle of the liquid crystal compound 38 in the optically-anisotropic layer 36 gradually increases from the inner side toward the outer side of the concentric circle. That is, in the optically-anisotropic layer 36 of the liquid crystal diffraction element 18, as the single period of the liquid crystal alignment pattern decreases, the tilt angle of the liquid crystal compound 38 increases.

In FIG. 3, in order to clearly indicate the tilted alignment state of the liquid crystal compound 38 in the optically-anisotropic layer 36, the liquid crystal compound in a state in which the liquid crystal alignment pattern is not provided is shown.

The same applies to FIGS. 9 to 12 described later.

As is well known, the optically-anisotropic layer (liquid crystal layer) having the liquid crystal alignment pattern in which the orientation of the optical axis derived from the liquid crystal compound 38 changes while continuously rotating in the one direction acts as a transmissive liquid crystal diffraction element which diffracts incident circularly polarized light in the one direction and the reverse direction according to the rotation direction of the optical axis and the turning direction of the incident circularly polarized light.

Specifically, in the optically-anisotropic layer 36 having the liquid crystal alignment pattern in which the orientation of the optical axis of the liquid crystal compound 38 changes while continuously rotating in the one direction, a diffraction direction (refraction direction) of transmitted light depends on the rotation direction of the optical axes of the liquid crystal compounds 38. That is, in the liquid crystal alignment pattern, in a case where the rotation directions of the optical axes of the liquid crystal compounds 38 in the one direction are opposite to each other, the diffraction direction of transmitted light is opposite to the one direction in which the optical axis rotates.

In addition, in the optically-anisotropic layer 36 having the liquid crystal alignment pattern in which the orientation of the optical axis of the liquid crystal compound 38 changes while continuously rotating in the one direction, the diffraction direction of transmitted light varies depending on the turning direction of the incident circularly polarized light. That is, in the liquid crystal alignment pattern, the diffraction direction of transmitted light is reversed between dextrorotatory circularly polarized light and levorotatory circularly polarized light.

Furthermore, in a case where an in-plane retardation (retardation in the plane direction) value is set to λ/2, the optically-anisotropic layer 36 has a function as a typical λ/2 plate, that is, has a function of imparting a phase difference of a half wavelength, that is, 180° to a polarized light component incident into the liquid crystal layer.

Accordingly, the circularly polarized light which is incident into and diffracted by the optically-anisotropic layer 36 has an opposite turning direction. That is, the dextrorotatory circularly polarized light incident into and diffracted by the optically-anisotropic layer 36 is emitted as levorotatory circularly polarized light; and the levorotatory circularly polarized light is emitted as dextrorotatory circularly polarized light.

In the optically-anisotropic layer 36 of the liquid crystal diffraction element 18, a length over which the orientation of the optical axis derived from the liquid crystal compound in the liquid crystal alignment pattern rotates by 180° in the one direction in which the orientation of the optical axis of the liquid crystal compound 38 changes while continuously rotating is set as a single period. That is, in the optically-anisotropic layer 36 as the liquid crystal diffraction element, the single period is a single period as a diffraction structure.

In the liquid crystal diffraction element 18 in the example shown in the drawing, the length of the single period of the optically-anisotropic layer 36 gradually decreases from the inner side toward the outer side.

Here, in the liquid crystal layer having the liquid crystal alignment pattern in which the orientation of the optical axis of the liquid crystal compound 38 changes while continuously rotating in the one direction, the diffraction angle increases as the length of the single period decreases. Accordingly, in the optically-anisotropic layer 36 having the concentric circular liquid crystal alignment pattern, the diffraction angle gradually increases from the center of the concentric circle toward the outer direction.

As described above, in the optically-anisotropic layer 36 in the example shown in the drawing, as the single period of the liquid crystal alignment pattern decreases, the tilt angle of the liquid crystal compound 38 increases.

Accordingly, the optically-anisotropic layer 36 having the concentric circular liquid crystal alignment pattern with the liquid crystal alignment pattern in which the optical axis derived from the liquid crystal compound changes while continuously rotating in a radial shape can transmit incidence ray (light beam) by diverging or focusing the ray depending on the rotation direction of the optical axis of the liquid crystal compound 38 and the turning direction of the incident circularly polarized light.

In other words, the liquid crystal diffraction element 18 including the optically-anisotropic layer 36 acts as a concave lens in a case where dextrorotatory circularly polarized light is incident and acts as a convex lens in a case where levorotatory circularly polarized light, depending on the turning direction of the incident circularly polarized light. Alternatively, the liquid crystal diffraction element 18 acts as a convex lens in a case where dextrorotatory circularly polarized light is incident, and acts as a concave lens in a case where levorotatory circularly polarized light is incident.

In order to simplify the drawing to clarify the configuration of the liquid crystal diffraction element 18 in FIGS. 1 and 3, only the liquid crystal compound 38 (liquid crystal compound molecule) on the surface of the alignment film 34 in the optically-anisotropic layer 36 is also shown. However, as conceptually shown in FIG. 2, the optically-anisotropic layer 36 has a structure in which the aligned liquid crystal compounds 38 are stacked in the thickness direction, similarly to a liquid crystal layer formed of a composition containing a typical liquid crystal compound.

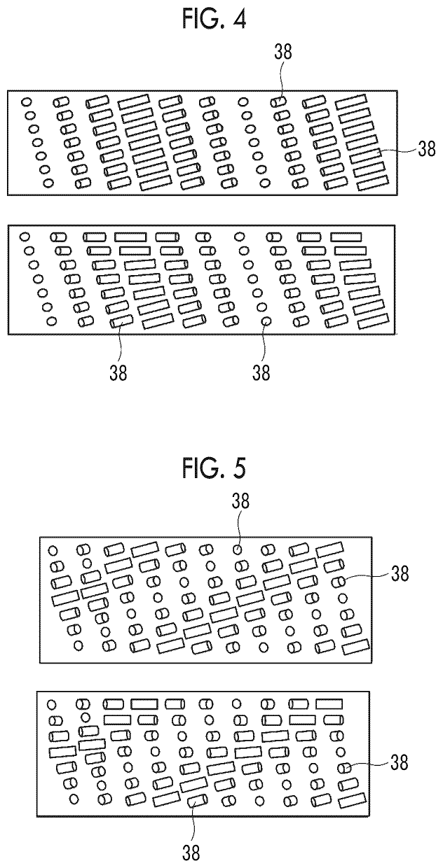

In addition, in the liquid crystal diffraction element 18 in the example shown in the drawing, the tilt angle of the liquid crystal compound 38 in the optically-anisotropic layer 36 may be the same in the entire thickness direction as shown in the upper part of FIG. 4, or may be different in the thickness direction as shown in the lower part of FIG. 4 at the same position in the plane.

In addition, in the liquid crystal diffraction element according to the embodiment of the present invention, the liquid crystal compound 38 may be twisted and aligned in the thickness direction as in an optically-anisotropic layer 36B shown in FIG. 15 described later. Even in the configuration, the tilt angle of the liquid crystal compound 38 may be the same in the entire region in the twisted direction of the liquid crystal compound as shown in the upper part of FIG. 5, or may be different in the twisted direction as shown in the lower part of FIG. 5.

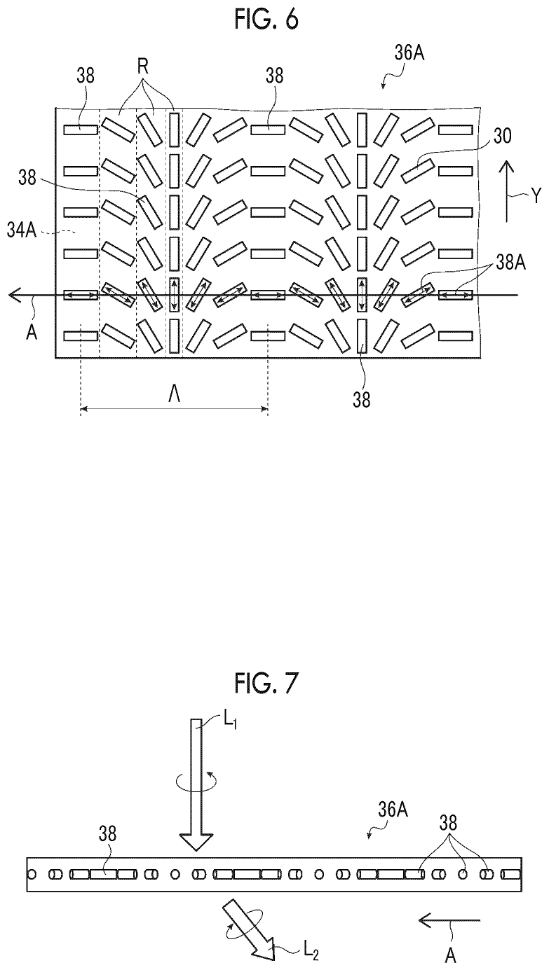

Hereinafter, the action of the optically-anisotropic layer 36 will be described in detail with reference to an optically-anisotropic layer 36A having a liquid crystal alignment pattern in which an optical axis 38A derived from the liquid crystal compound 38 changes while continuously rotating in the one direction indicated by an arrow A, conceptually shown in a plan view of FIG. 6.

Even in the concentric circular liquid crystal alignment pattern shown in FIG. 1 in which the optical axis changes while continuously rotating in one direction in a radial shape from the inner side toward the outer side, the same optical effects as those of the liquid crystal alignment pattern shown in FIG. 6 can be exhibited for the one direction in which the optical axis changes while continuously rotating.

In the following description, the optical axis 38A derived from the liquid crystal compound 38 will also be referred to as “optical axis 38A of the liquid crystal compound 38” or “optical axis 38A”.

In the optically-anisotropic layer 36A, the liquid crystal compound 38 is two-dimensionally aligned in a plane parallel to the one direction indicated by the arrow A and a Y direction orthogonal to the arrow A direction. In FIGS. 1 and 2 described below, the Y direction is a direction orthogonal to the paper plane.

In the following description, “one direction indicated by the arrow A” will also be simply referred to as “arrow A direction”.

In the optically-anisotropic layer 36 shown in FIG. 1, a circumferential direction of the concentric circle in the concentric circular liquid crystal alignment pattern corresponds to the Y direction in FIG. 6.

The optically-anisotropic layer 36A has a liquid crystal alignment pattern in which the orientation of the optical axis 38A derived from the liquid crystal compound 38 changes while continuously rotating in the arrow A direction in a plane of the optically-anisotropic layer 36A.

Specifically, the “orientation of the optical axis 38A of the liquid crystal compound 38 changes while continuously rotating in the arrow A direction (predetermined one direction)” means that an angle between the optical axis 38A of the liquid crystal compound 38, which is arranged in the arrow A direction, and the arrow A direction varies depending on positions in the arrow A direction, and the angle between the optical axis 38A and the arrow A direction sequentially changes from θ to θ+180° or to θ−180° in the arrow A direction.

Meanwhile, regarding the liquid crystal compound 38 forming the optically-anisotropic layer 36A, the liquid crystal compounds 38 in which the orientations of the optical axes 38A are the same as one another are arranged at equal intervals in the Y direction orthogonal to the arrow A direction, that is, the Y direction orthogonal to one direction in which the optical axes 38A continuously rotate.

In other words, regarding the liquid crystal compound 38 forming the optically-anisotropic layer 36, in the liquid crystal compounds 38 arranged in the Y direction, angles between the orientations of the optical axes 38A and the arrow A direction are the same.

In the optically-anisotropic layer 36 shown in FIG. 1, a region where the orientations of the optical axes 38A are the same is formed in an annular shape where the centers match with each other, and a concentric circular liquid crystal alignment pattern is formed.

As described above, in the liquid crystal alignment pattern in which the optical axis 38A continuously rotates in the one direction, the length (distance) over which the optical axis 38A of the liquid crystal compound 38 rotates by 180° is a length Λ of the single period in the liquid crystal alignment pattern.

That is, in the optically-anisotropic layer 36A shown in FIG. 6, the length (distance) over which the optical axis 38A of the liquid crystal compound 38 rotates by 180° in the arrow A direction in which the orientation of the optical axis 38A changes while continuously rotating in a plane is set as the single period Λ in the liquid crystal alignment pattern. In other words, the single period Λ in the liquid crystal alignment pattern is defined as a distance from θ to θ+1800 of the angle between the optical axis 38A of the liquid crystal compound 38 and the arrow A direction.

That is, a distance between centers of two liquid crystal compounds 38 in the arrow A direction is the single period A, the two liquid crystal compounds having the same angle in the arrow A direction. Specifically, as shown in FIG. 6, a distance between centers of two liquid crystal compounds 38 in the arrow A direction, in which the arrow A direction and the direction of the optical axis 38A match with each other, is the single period A.

With regard to the optically-anisotropic layer 36A (optically-anisotropic layer 36), in the liquid crystal alignment pattern, the single period Λ is repeated in the arrow A direction, that is, in the one direction in which the orientation of the optical axis 38A changes while continuously rotating.

As described above, the optically-anisotropic layer 36A having such a liquid crystal alignment pattern is also a transmissive liquid crystal diffraction element, and the single period Λ is the period (single period) of the diffraction structure.

In the liquid crystal compounds arranged in the Y direction in the optically-anisotropic layer 36A, angles between the optical axes 38A and the arrow A direction are the same. A region where the liquid crystal compounds 38 in which the angles between the optical axes 38A and the arrow A direction are the same are arranged in the Y direction will be referred to as a region R.

In this case, it is preferable that an in-plane retardation (Re) value of each of the regions R is a half wavelength, that is, λ/2. The in-plane retardation is calculated from a product of a difference in refractive index Δn due to refractive index anisotropy of the region R and a thickness of the liquid crystal layer. Here, the difference in refractive index due to the refractive index anisotropy of the regions R in the liquid crystal layer is defined by a difference between a refractive index of a direction of an in-plane slow axis of the region R and a refractive index of a direction orthogonal to the direction of the slow axis. That is, the difference Δn in refractive index due to the refractive index anisotropy of the regions R is the same as a difference between a refractive index of the liquid crystal compound 38 in the direction of the optical axis 38A and a refractive index of the liquid crystal compound 38 in a direction perpendicular to the optical axis 38A in a plane of the region R. That is, the above-described difference in refractive index Δn is the same as the difference in refractive index of the liquid crystal compound.

In the liquid crystal diffraction element 18 having the concentric circular liquid crystal alignment pattern with the liquid crystal alignment pattern in which the optical axis 38A continuously rotates in one direction in a radial shape, regions where the orientations of the optical axes 38A are the same and that are formed in an annular shape where the centers match with each other correspond to the region R in FIG. 6.

In a case where circularly polarized light is incident into the optically-anisotropic layer 36A, the light is refracted and a direction of the circularly polarized light is changed.

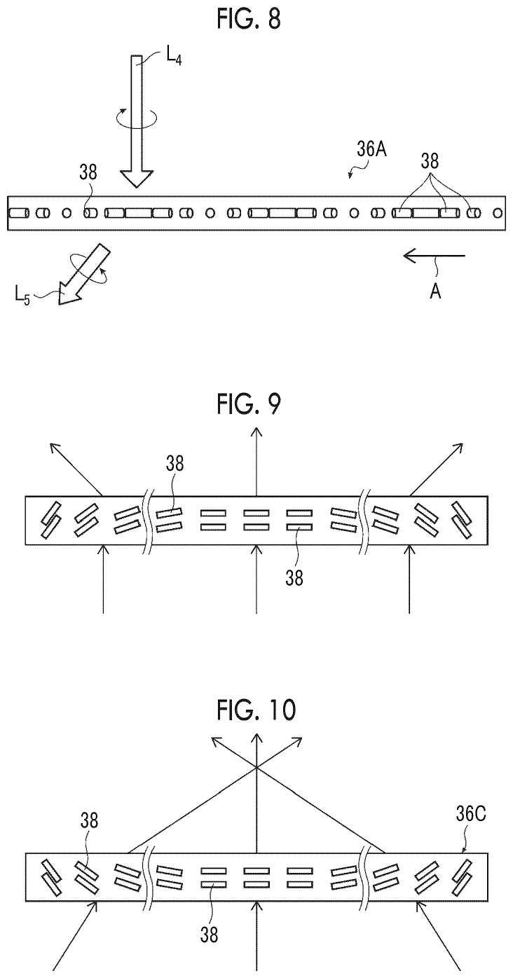

The action is conceptually shown in FIGS. 7 and 8. In the optically-anisotropic layer 36A, a value of a product of a difference in refractive index of the liquid crystal compound and a thickness of the liquid crystal layer is λ/2.

As described above, the action is also the same in the liquid crystal diffraction element 18 having the concentric circular liquid crystal alignment pattern with the liquid crystal alignment pattern in which the optical axis 38A continuously rotates in the one direction in a radial shape.

As shown in FIG. 7, in a case where the value of the product of the difference in refractive index of the liquid crystal compound and the thickness of the optically-anisotropic layer in the optically-anisotropic layer 36 is λ/2 and an incidence ray L₁ as levorotatory circularly polarized light is incident into the optically-anisotropic layer 36, the incidence ray L₁ is transmitted through the optically-anisotropic layer 36 to be imparted with a retardation of 180°, and a transmitted ray L₂ is converted into dextrorotatory circularly polarized light.

In addition, the liquid crystal alignment pattern formed in the optically-anisotropic layer 36 is a pattern which is periodic in the arrow A direction, so that the transmitted ray L₂ travels in a direction different from a traveling direction of the incidence ray L₁. In this way, the incidence ray L₁ of the levorotatory circularly polarized light is converted into the transmitted ray L₂ of the dextrorotatory circularly polarized light, which is tilted by a predetermined angle in the opposite direction to the arrow A direction with respect to an incidence direction.

On the other hand, as shown in FIG. 8, in a case where the value of the product of the difference in refractive index of the liquid crystal compound of the optically-anisotropic layer 36 and the thickness of the optically-anisotropic layer 36 is λ/2 and an incidence ray L₄ as dextrorotatory circularly polarized light is incident into the optically-anisotropic layer 36, the incidence ray L₄ is transmitted through the optically-anisotropic layer 36 to be imparted with a retardation of 180° and is converted into a transmitted ray L₅ of a levorotatory circularly polarized light.

In addition, the liquid crystal alignment pattern formed in the optically-anisotropic layer 36 is a pattern which is periodic in the arrow A direction, so that the transmitted ray L₅ travels in a direction different from a traveling direction of the incidence ray L₄. In this case, the transmitted ray L₅ travels in a direction different from the transmitted ray L₂, that is, in a direction opposite to the arrow A direction with respect to the incidence direction. In this way, the incidence ray L₄ is converted into the transmitted ray L₅ of the levorotatory circularly polarized light, which is tilted by a predetermined angle in the arrow A direction with respect to the incidence direction.

As described above, by changing the single period Λ of the liquid crystal alignment pattern formed in the optically-anisotropic layer 36A, diffraction angles of the transmitted rays L₂ and L₅ can be adjusted. Specifically, as the single period Λ of the liquid crystal alignment pattern decreases, light transmitted through the liquid crystal compounds 38 adjacent to each other more strongly interfere with each other, so that the transmitted rays L₂ and L₅ can be more largely diffracted.

In the liquid crystal diffraction element according to the embodiment of the present invention, the single period Λ of the liquid crystal alignment pattern in the optically-anisotropic layer is not particularly limited. That is, the single period of the liquid crystal alignment pattern may be appropriately set depending on the application of the liquid crystal diffraction element, the optical characteristics required for the liquid crystal diffraction element, such as the focal length, the size of the liquid crystal diffraction element, and the like, to obtain a desired optical characteristic. In addition, in a case where the optically-anisotropic layer has the liquid crystal alignment pattern in which the single period Λ changes in the plane as in the example shown in the drawing, a degree of the change may be set in the same manner.

Here, as the single period of the liquid crystal alignment pattern decreases, a decrease in diffraction efficiency described later increases. That is, as the single period of the liquid crystal alignment pattern decreases, the effect of the present invention in which the liquid crystal compound is tilted is more significantly obtained.

In consideration of this point, in the liquid crystal alignment pattern of the optically-anisotropic layer, it is preferable that a region having the length of the single period Λ of 100 μm or less is included; it is more preferable that a region having the length of the single period Λ of 10 μm or less is included; it is still more preferable that a region having the length of the single period Λ of 2 μm or less is included; and it is particularly preferable that a region having the length of the single period Λ of 1 μm or less is included.

The lower limit of the single period Λ of the liquid crystal alignment pattern in the optically-anisotropic layer is not particularly limited. However, in consideration of the accuracy, the diffraction efficiency, and the like of the liquid crystal alignment pattern, the single period Λ is preferably 0.1 μm or more.

A preferred single period of the liquid crystal alignment pattern varies depending on the application of the liquid crystal diffraction element, and the like. For example, in a case of a liquid crystal diffraction element used for wide angle incidence as shown in FIGS. 10 to 12, even in a case where the single period Λ is several tens of μm or more, the effect of tilting the liquid crystal compound can be suitably obtained.

In addition, in the optically-anisotropic layer 36A, by reversing the rotation direction of the optical axes 38A of the liquid crystal compounds 38 which rotate in the arrow A direction, the diffraction direction of the transmitted light can be reversed.

Furthermore, in the optically-anisotropic layer 36A, the diffraction direction of the transmitted light is reversed depending on the turning direction of the incident circularly polarized light. That is, in the optically-anisotropic layer 36A, the diffraction directions of the transmitted light are opposite to each other between the dextrorotatory circularly polarized light and the levorotatory circularly polarized light.

Regarding the above points, the same applies to the optically-anisotropic layer 36 (liquid crystal diffraction element 18) having the concentric circular liquid crystal alignment pattern as described above.

Accordingly, the liquid crystal diffraction element 18 including the optically-anisotropic layer 36 having the concentric circular liquid crystal alignment pattern acts as a convex lens (condenser lens) or a concave lens (diverging lens) depending on the turning direction of the incident circularly polarized light. In the examples shown in FIGS. 1 to 8, the liquid crystal diffraction element 18 acts as a convex lens in a case where levorotatory circularly polarized light is incident, and acts as a concave lens in a case where dextrorotatory circularly polarized light is incident.

As described above, in a case where the liquid crystal diffraction element 18 (liquid crystal lens) is used in a head mounted display, it is necessary to shorten the focal length of the liquid crystal diffraction element 18 in order to reduce the thickness and size of the optical system.

In addition, as described above, in the liquid crystal diffraction element having the liquid crystal alignment pattern in which the optical axis 38A of the liquid crystal compound 38 continuously rotates in the one direction, as the single period Λ over which the optical axis 38A rotates by 180° decreases, the diffraction angle of light increases.

However, in the liquid crystal diffraction element having such a liquid crystal alignment pattern, in a case where the single period Λ decreases, there is a problem in that the diffraction efficiency decreases, for example, the amount of zero-order light which is not diffracted by the liquid crystal diffraction element increases. In particular, in a case where the single period Λ decreases to the level of 1 μm, the decrease in diffraction efficiency is large.

The present inventors have conducted intensive studies to solve the problem.

As a result, it is found that, in the optically-anisotropic layer, by setting the liquid crystal compound constituting the optically-anisotropic layer of the liquid crystal diffraction element in a state of having an angle with respect to the surface of the optically-anisotropic layer, that is, in a state in which the liquid crystal compound 38 has a tilt angle with respect to the surface of the optically-anisotropic layer 36, even in a case where the single period in the liquid crystal diffraction element decreases, the decrease in diffraction efficiency can be suppressed.

The present invention has been made by obtaining the above-described findings, and in the optically-anisotropic layer which mainly acts as a diffraction element in the liquid crystal diffraction element, on at least one surface of the optically-anisotropic layer, the optically-anisotropic layer has a region in which the liquid crystal compound has a tilt angle with respect to the surface of the optically-anisotropic layer. Furthermore, the optically-anisotropic layer has regions having different tilt angles of the liquid crystal compounds in a plane.

Since the liquid crystal diffraction element according to the embodiment of the present invention has such a configuration, even in a case where the single period Λ of the liquid crystal alignment pattern in the optically-anisotropic layer 36 is as short as 1 μm or less, excellent diffraction efficiency can be obtained.

Therefore, with the liquid crystal diffraction element according to the embodiment of the present invention, for example, in a case where the liquid crystal diffraction element is used for a liquid crystal lens with a short focal length, light can be focused with high light focusing efficiency.

Since the liquid crystal diffraction element 18 in the example shown in the drawing is a liquid crystal lens, the single period Λ in the liquid crystal alignment pattern of the optically-anisotropic layer 36 gradually decreases from the inner side toward the outer side of the concentric circle.

Accordingly, in the optically-anisotropic layer 36 of the liquid crystal diffraction element 18, the tilt angle of the liquid crystal compound 38 gradually increases from the inner side toward the outer side of the concentric circle. Specifically, as conceptually shown in FIG. 3, in the optically-anisotropic layer 36, in the center region of the concentric circle, the liquid crystal compound 38 is aligned in parallel with both surfaces of the optically-anisotropic layer 36; and in a region slightly spaced from the center of the concentric circle, the liquid crystal compound 38 has a tilt angle, and the tilt angle of the liquid crystal compound 38 gradually increases from the inner side toward the outer side of the concentric circle.

The tilt angle of the liquid crystal compound 38 may be uniform in the entire region in the thickness direction or may vary in the thickness direction at the same position in the plane of the optically-anisotropic layer 36.

That is, in the optically-anisotropic layer of the liquid crystal diffraction element according to the embodiment of the present invention, a region where the liquid crystal compound 38 does not have the tilt angle, that is, a region where the liquid crystal compound is not tilt-aligned may be provided in at least a part of the plane.

In addition, in the liquid crystal diffraction element according to the embodiment of the present invention, the liquid crystal compound 38 may have a tilt angle in the entire in-plane region of the optically-anisotropic layer, that is, the liquid crystal compound 38 may be tilt-aligned in the entire in-plane region of the optically-anisotropic layer.

With regard to the gradual change in the tilt angle of the liquid crystal compound 38 in the optically-anisotropic layer 36, the change in the tilt angle may be a continuous change or a stepwise change in which regions having the same tilt angle are provided. Furthermore, in the optically-anisotropic layer 36, a region where the tilt angle continuously changes and a region where the tilt angle changes stepwise may be mixed.

The same applies to the other configuration in which the tilt angle of the liquid crystal compound 38 gradually changes.

In addition, a direction of the tilt of the liquid crystal compound in the optically-anisotropic layer is set to a direction in which the liquid crystal compound rises toward the diffraction direction of light by the liquid crystal diffraction element.

That is, in a case where the liquid crystal diffraction element 18 (optically-anisotropic layer 36) in the example shown in the drawing acts as a convex lens which focuses light, the liquid crystal compound 38 is tilted to rise toward the center, that is, the focusing direction as shown in FIG. 3. On the contrary, in a case where the liquid crystal diffraction element acts as a concave lens which emits light as conceptually shown in FIG. 9, the liquid crystal compound 38 is tilted to rise from the inner side to the outer side, that is, in the direction in which light is emitted, opposite to that in FIG. 3.

The liquid crystal diffraction element according to the embodiment of the present invention can also be used as a liquid crystal diffraction element which focuses light by wide angle incidence, as conceptually shown in FIG. 10 using an optically-anisotropic layer 36C as an example.

In such an application, the diffraction efficiency decreases due to oblique incidence of light into the liquid crystal diffraction element. Even in this case, by providing the liquid crystal compound with the tilt angle with respect to the surface of the optically-anisotropic layer, the decrease in diffraction efficiency can be suppressed. Here, in this case, as the incidence angle of light into the liquid crystal diffraction element (optically-anisotropic layer) increases, the diffraction efficiency of the liquid crystal diffraction element decreases. Accordingly, in the liquid crystal diffraction element which focuses light by wide angle incidence, it is preferable that the tilt angle of the liquid crystal compound increases in a region where the incidence angle of the light into the liquid crystal diffraction element increases. The same applies to the following aspect in which the light is incident as diverging light.

The incidence angle is an angle with respect to a normal line of the liquid crystal diffraction element, that is, a polar angle. In addition, the normal line is a line in a direction orthogonal to the surface of the sheet-like material.

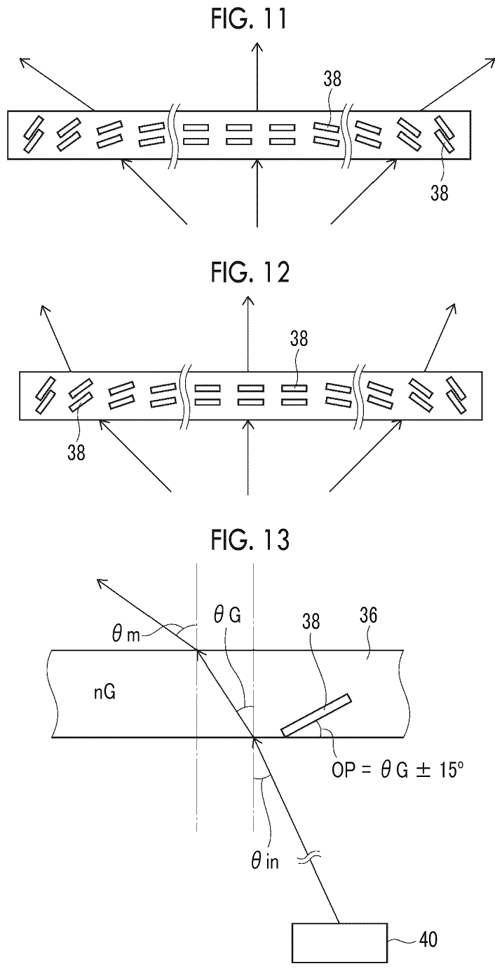

In addition, the liquid crystal diffraction element according to the embodiment of the present invention can also be used for diverging light. For example, as shown in FIG. 11, the diverging light may be incident into the liquid crystal diffraction element, and the light may be further diffused by the liquid crystal diffraction element. FIG. 11 shows only the optically-anisotropic layer. In addition, in a case where the liquid crystal diffraction element is used as a concave lens, the liquid crystal compound is tilted to rise from the inner side to the outer side, that is, in the direction in which light is diffused, as described above.

Alternatively, as conceptually shown in FIG. 12, the divergence can be weakened by allowing the diverging light to be incident into the liquid crystal diffraction element which acts as a convex lens, and focusing the light by the liquid crystal diffraction element. FIG. 12 shows only the optically-anisotropic layer. Furthermore, the light to be focused may be incident into the liquid crystal diffraction element which acts as a convex lens to strengthen the focusing as shown in FIG. 10. Furthermore, although not shown, the light to be focused may be incident into the liquid crystal diffraction element which acts as a concave lens to weaken the focusing.

As described above, in the optically-anisotropic layer 36 of the liquid crystal diffraction element 18 in the example shown in the drawing, the single period Λ in the liquid crystal alignment pattern gradually decreases from the inner side toward the outer side of the concentric circle. Accordingly, in the liquid crystal diffraction element 18, as a preferred aspect, the tilt angle of the liquid crystal compound 38 in the optically-anisotropic layer 36 gradually increases from the inner side toward the outer side.

That is, in the optically-anisotropic layer of the liquid crystal diffraction element 18 in the example shown in the drawing, as the single period Λ in the liquid crystal alignment pattern decreases, the tilt angle of the liquid crystal compound 38 increases. In other words, in the optically-anisotropic layer of the liquid crystal diffraction element 18 in the example shown in the drawing, the tilt angle of the liquid crystal compound 38 increases in conjunction with the decrease of the single period Λ in the liquid crystal alignment pattern.

However, the liquid crystal diffraction element according to the embodiment of the present invention is not limited thereto.

That is, in the liquid crystal diffraction element according to the embodiment of the present invention, the tilt angle of the liquid crystal compound in the optically-anisotropic layer may be constant. Alternatively, in the liquid crystal diffraction element according to the embodiment of the present invention, the tilt angle of the liquid crystal compound in the optically-anisotropic layer may decrease in conjunction with the decrease of the single period Λ in the liquid crystal alignment pattern. Alternatively, in the liquid crystal diffraction element according to the embodiment of the present invention, the tilt angle of the liquid crystal compound in the optically-anisotropic layer may not be linked to the change in the single period Λ in the liquid crystal alignment pattern.

Here, in the liquid crystal diffraction element (optically-anisotropic layer), the diffraction efficiency decreases as the single period Λ in the liquid crystal alignment pattern decreases. In consideration of this point, it is preferable that the tilt angle of the liquid crystal compound in the optically-anisotropic layer increases as the single period Λ in the liquid crystal alignment pattern decreases.

In the liquid crystal diffraction element 18 in the example shown in the drawing, as a preferred aspect, the optically-anisotropic layer 36 acts as a convex lens, and the single period Λ in the liquid crystal alignment pattern gradually decreases from the inner side toward the outer side. That is, the optically-anisotropic layer 36 in the example shown in the drawing has regions having different lengths of the single period Λ in the plane.

However, the liquid crystal diffraction element according to the embodiment of the present invention is not limited thereto, and the single period Λ in the liquid crystal alignment pattern of the optically-anisotropic layer may be uniform over the entire surface.

In the liquid crystal diffraction element 18 according to the embodiment of the present invention, the tilt angle of the liquid crystal compound 38 in the optic ally-anisotropic layer 36 is not limited. That is, the tilt angle of the liquid crystal compound 38 may be appropriately set depending on the optical characteristics required for the liquid crystal diffraction element 18, the size of the liquid crystal diffraction element 18, the liquid crystal alignment pattern of the optically-anisotropic layer, the incidence angle of light into the liquid crystal diffraction element, and the like. In a case where the liquid crystal compound 38 has a tilt angle, that is, in a case where the angle between the liquid crystal compound 38 and the surface of the optically-anisotropic layer 36 is more than 0°, the tilt angle of the liquid crystal compound 38 is preferably 5° to 85°, more preferably 10° to 80°, and still more preferably 15° to 70°.

By setting the tilt angle of the liquid crystal compound 38 in the optically-anisotropic layer 36 to be 5° or more, it is preferable in that excellent diffraction efficiency can be obtained even in a case where the single period Λ of the liquid crystal alignment pattern is short, and excellent diffraction efficiency can be obtained even in a case where the incidence angle of light into the liquid crystal diffraction element is large.

In addition, it is preferable that the tilt angle of the liquid crystal compound 38 in the optically-anisotropic layer 36 is set to 85° or less from the viewpoint of alignment stability and the like.

In addition, in the liquid crystal diffraction element 18 according to the embodiment of the present invention, the optically-anisotropic layer 36 has regions having different tilt angles of the liquid crystal compound 38 in the plane.

In the optically-anisotropic layer 36, a difference in tilt angle of the liquid crystal compound 38 is not particularly limited. That is, the difference in tilt angle of the liquid crystal compound 38 in the optically-anisotropic layer 36 may be appropriately set depending on the optical characteristics required for the liquid crystal diffraction element 18, the size of the liquid crystal diffraction element 18, the liquid crystal alignment pattern of the optically-anisotropic layer, the incidence angle of light into the liquid crystal diffraction element, and the like. The difference in tilt angle of the liquid crystal compound 38 in the optically-anisotropic layer 36 is preferably 5° to 85°, more preferably 10° to 80°, and still more preferably 15° to 70°.

By setting the difference in tilt angle of the liquid crystal compound 38 in the optically-anisotropic layer 36 to be 5° or more, it is preferable in that excellent diffraction efficiency can be obtained even in a case where the single period Λ of the liquid crystal alignment pattern is short, and excellent diffraction efficiency can be obtained even in a case where the incidence angle of light into the liquid crystal diffraction element is large.

In addition, it is preferable that the difference in tilt angle of the liquid crystal compound 38 in the optically-anisotropic layer 36 is set to 85° or less from the viewpoint of alignment stability and the like in the plane.

In this case, the difference in tilt angle of the liquid crystal compound 38 also includes a liquid crystal compound 38 having a minimum value of the tilt angle of 0°, that is, having no tilt angle.

In the present invention, specifically, in a case where the liquid crystal compound is a rod-like liquid crystal compound, the tilt angle of the liquid crystal compound is an acute angle formed by one surface of the optically-anisotropic layer and a longitudinal direction (optical axis (slow axis)) of the rod-like liquid crystal compound.

In addition, in a case where the liquid crystal compound is a disk-like liquid crystal compound, the angle is an acute angle formed by one surface of the optically-anisotropic layer and a disc plane of the disk-like liquid crystal compound.

In the definition, the acute angle also includes a right angle.

Here, in the liquid crystal diffraction element according to the embodiment of the present invention, it is preferable that the tilt angle of the liquid crystal compound 38 is close to a traveling direction of light in the optically-anisotropic layer 36.

That is, in the liquid crystal diffraction element according to the embodiment of the present invention, it is preferable that the tilt angle of the liquid crystal compound 38 is close to an angle between the traveling direction of light in the optically-anisotropic layer 36 and the normal line of the optically-anisotropic layer 36.

Specifically, in the optical device according to the embodiment of the present invention, including the liquid crystal diffraction element according to the embodiment of the present invention and a light source, as conceptually shown in FIG. 13, in a case where light is incident at an angle θin from a light source 40, it is preferable that, in a case where a refractive index of the optically-anisotropic layer 36 is indicated by nG and an emission angle of light emitted from the liquid crystal diffraction element 18 (optically-anisotropic layer 36) into the air is indicated by θm, a tilt angle θP [°] of the liquid crystal compound is ±15° of an angle θG [°] calculated by the following expression.

$$Sin θ G = Sin θ m / nG$$

$$θ P {[}^{∘} ] = θG \pm 15 {[}^{∘} ] , that is ,$$

$$θ G {[}^{∘} ] - {15}^{∘} \leq θ P {[}^{∘} ] \leq θ G {[}^{∘} ] + 1 {5}^{o}$$

In FIG. 13, an one-dot chain line is the normal line of the optically-anisotropic layer 36.

By having such a configuration, a liquid crystal diffraction element having an excellent diffraction efficiency can be obtained even in a case where the single period Λ of the liquid crystal alignment pattern in the optically-anisotropic layer 36 is short.

In addition, the optical device according to the embodiment of the present invention may include a circularly polarizing plate (circularly polarizer) which converts light incident into the liquid crystal diffraction element 18 into circularly polarized light depending on a polarization state of light emitted from the light source 40.

In the optical device according to the embodiment of the present invention, the light source is not limited, and various known light sources can be used.

Accordingly, the light source may be a light source which emits white light, a light source which emits monochromatic light such as red light, green light, and blue light, or various image display elements such as a liquid crystal display and an organic electroluminescent display. The optical device (liquid crystal diffraction element) according to the embodiment of the present invention can be suitably used as a lens in a VR system such as a head mounted display, and thus, various image display elements are suitably exemplified as the light source.

Here, the liquid crystal diffraction element according to the embodiment of the present invention may include a plurality of layers of the optically-anisotropic layers as described later.

In this case, the refractive index nG of the optically-anisotropic layer is an average refractive index of the plurality of layers of the optically-anisotropic layers. In addition, the tilt angle θP [°] of the liquid crystal compound is an average tilt angle in the plurality of the optically-anisotropic layers in consideration of the thickness of the respective layers at a position where light is emitted from the liquid crystal diffraction element 18 (optically-anisotropic layer 36) into the air.

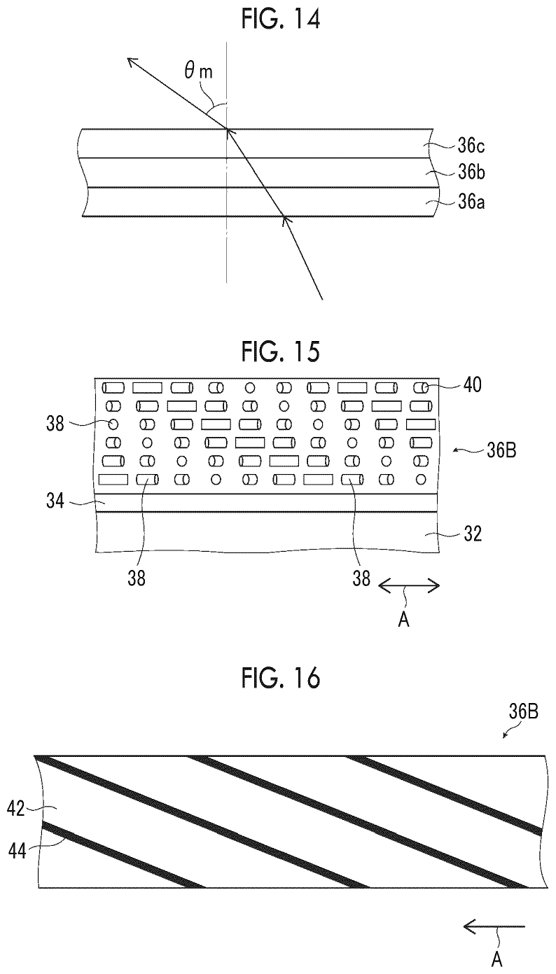

For example, as conceptually shown in FIG. 14, in a case where the liquid crystal diffraction element includes optically-anisotropic layers 36a, 36b, and 36c, the refractive index nG of the optically-anisotropic layer is calculated as an average refractive index of a refractive index of the optically-anisotropic layer 36a, A refractive index of the optically-anisotropic layer 36b, and a refractive index of the optically-anisotropic layer 36c; and the above-described expression is used for calculating θG [°].

In addition, the tilt angle θP may be an average tilt angle θP [°] of tilt angles of the respective optically-anisotropic layers, calculated by taking into account the thicknesses of the respective optically-anisotropic layers at a position where light is emitted from the liquid crystal diffraction element 18 (optically-anisotropic layer 36) into the air, that is, on the normal line (one-dot chain line) to the light emission position shown in FIG. 14, in which the tilt angle θP is θG±15 [°].

Specifically, the following expression may be satisfied by setting dA as the thickness of the optically-anisotropic layer 36a, θA as the tilt angle of the liquid crystal compound at the light emission position (on the one-dot chain line in FIG. 14) of the optically-anisotropic layer 36a, dB as the thickness of the optically-anisotropic layer 36b, OB as the tilt angle of the liquid crystal compound at the light emission position (same as described above) of the optically-anisotropic layer 36b, dC as the thickness of the optically-anisotropic layer 36c, and OC as the tilt angle of the liquid crystal compound at the light emission position (same as described above) of the optically-anisotropic layer 36c.

$$( θ A \times dA + θ B \times dB + θ C \times dC ) / ( dA + dB + dC ) [ ° ] = θ P [ ° ] = θ G \pm 15 [ ° ]$$

As described above, in the liquid crystal diffraction element according to the embodiment of the present invention, the optically-anisotropic layer 36 is formed of a liquid crystal composition containing a liquid crystal compound, and has a liquid crystal alignment pattern in which the orientation of the optical axis 38A of the liquid crystal compound changes while continuously rotating in at least one in-plane direction.

Here, in the optically-anisotropic layer shown in FIG. 2, the liquid crystal compound 38 faces the same direction in a thickness direction.

However, the present invention is not limited thereto, and the liquid crystal compound 38 may be helically twisted and aligned in the thickness direction as conceptually shown in an optically-anisotropic layer 36B of FIG. 15. In this case, a twisted angle of the liquid crystal compound 38 in the thickness direction is preferably less than 360°.

In a cross-sectional image obtained by observing a cross section of the optically-anisotropic layer having the above-described liquid crystal alignment pattern with a scanning electron microscope (SEM) in a thickness direction along a direction in which the optical axis continuously rotates, the optically-anisotropic layer has the bright portions 42 and the dark portions 44, which extend from one surface to the other surface.

In the following description, an image obtained by observing a cross section of such an optically-anisotropic layer with SEM will be also referred to as “cross-sectional SEM image” for convenience.

The bright portions 42 and the dark portions 44 in the cross-sectional SEM image are observed due to the liquid crystal phase having the liquid crystal alignment pattern.

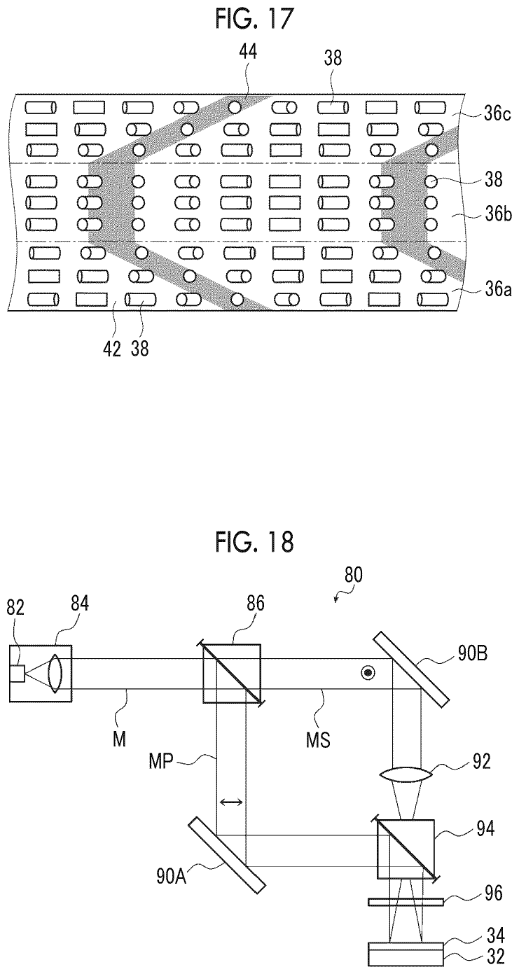

The optically-anisotropic layer 36 in which the liquid crystal compound 38 is not helically twisted and aligned in the thickness direction shown in FIG. 2 has bright portions 42 and dark portions 44, which extend from one surface to the other surface in the thickness direction, that is, orthogonal to the surface in a cross-sectional SEM image (see FIG. 17).

On the other hand, as conceptually shown in FIG. 16, in the cross-sectional SEM image, the optically-anisotropic layer 36B in which the liquid crystal compound 38 is helically twisted and aligned in the thickness direction has the bright portions 42 and the dark portions 44, which are tilted with respect to the thickness direction of the optically-anisotropic layer 36B, that is, with respect to the surface, and extend from one surface to the other surface.

In this way, in the optically-anisotropic layer, the diffraction efficiency can be increased by helically twisting and aligning the liquid crystal compound in the thickness direction.

In FIG. 15 and FIG. 17 described later, the liquid crystal compound is shown in a state in which the tilt angle is not present in order to clearly show the alignment state of the liquid crystal compound 38.

However, in the liquid crystal diffraction element according to the embodiment of the present invention, as described above, the optically-anisotropic layer has a region where the liquid crystal compound 38 has a tilt angle with respect to the surface of the optically-anisotropic layer, and further has a region where the tilt angle of the liquid crystal compound 38 varies in the plane of the optically-anisotropic layer.

In the optically-anisotropic layer having the dark portions (bright portions) which are inclined with respect to the surface of the optically-anisotropic layer as in the optically-anisotropic layer 36B shown in FIG. 16 (FIG. 15), the tilt angle of the dark portions with respect to the surface and the tilt angle of the liquid crystal compound may not necessarily match with each other.

That is, in the liquid crystal diffraction element according to the embodiment of the present invention, in the optically-anisotropic layer having the dark portions inclined with respect to the surface of the optically-anisotropic layer, the tilt angle of the dark portions with respect to the surface may match with the tilt angle of the liquid crystal compound in the entire plane direction, may be different from each other in the entire plane direction, or a region where they match with each other and a region where they are different from each other may be mixed in the plane direction.

In the optically-anisotropic layer 36A in which the liquid crystal compound 38 is helically twisted and aligned in the thickness direction as shown in FIG. 15, an angle of the dark portions 44 (the bright portions 42) with respect to the surface in the cross-sectional SEM image can be adjusted by the length of the single period in the liquid crystal alignment pattern described above and a magnitude of the twist of the liquid crystal compound 38 which is twisted and aligned in the thickness direction.

Specifically, as the single period in the liquid crystal alignment pattern decreases, the angle of the dark portions 44 with respect to the surface increases. In addition, as the twist in the thickness direction decreases, the angle of the dark portions 44 with respect to the surface increases.

The helically twisted alignment of the liquid crystal compound in the optically-anisotropic layer can be achieved by adding a chiral agent to the liquid crystal composition for forming the optically-anisotropic layer, which will be described later. By selecting and adjusting the type and amount of the chiral agent, the twisted direction of the liquid crystal compound 38 and the degree of twisting of the liquid crystal compound 38 can be adjusted.

The liquid crystal diffraction element according to the embodiment of the present invention may include a plurality of layers of the optically-anisotropic layers. In this case, in the plurality of the optically-anisotropic layers, it is preferable that at least one layer is an optically-anisotropic layer in which the liquid crystal compound 38 is twisted and aligned in the thickness direction as shown in FIGS. 15 and 16.

In addition, in the optically-anisotropic layer in which the liquid crystal compound 38 is twisted and aligned in the thickness direction, one or more of the twisted angle of the liquid crystal compound 38, the twisted direction of the liquid crystal compound 38, and the like may be different.

That is, in a case where the liquid crystal diffraction element according to the embodiment of the present invention includes a plurality of the optically-anisotropic layers, it is preferable that the liquid crystal diffraction element includes a plurality of optically-anisotropic layers having different tilt angles of the dark portions in the cross-sectional SEM image. By having such a configuration, the diffraction efficiency of light by the liquid crystal diffraction element (optically-anisotropic layer) can be improved.

As an example, as conceptually shown in FIG. 17, the optically-anisotropic layer 36b in which the liquid crystal compound 38 is not helically twisted and aligned in the thickness direction may be sandwiched between the optically-anisotropic layers 36a and 36c which have opposite helical twisted directions of the liquid crystal compound 38 in the thickness direction; and a region having the bright portions 42 and the dark portions 44 extending in the thickness direction may be sandwiched between regions where the inclined directions of the bright portions 42 and the dark portions 44 are opposite to each other.

In addition, in the liquid crystal diffraction element according to the embodiment of the present invention, the configuration including the plurality of the optically-anisotropic layers is not limited to the three-layer configuration shown in FIG. 17, and various configurations can be used. That is, the liquid crystal diffraction element according to the embodiment of the present invention may have a two-layer configuration of the optically-anisotropic layer 36a and the optically-anisotropic layer 36b in which the helical twisted directions of the liquid crystal compound 38 in the thickness direction are opposite to each other, or a four-layer configuration in which two of the two-layer configurations are laminated. In addition, the liquid crystal diffraction element according to the embodiment of the present invention may have a configuration including two layers of the optically-anisotropic layer 36a and the optically-anisotropic layer 36b in which the liquid crystal compound 38 is not twisted and aligned. In addition, the liquid crystal diffraction element according to the embodiment of the present invention may have a configuration in which a plurality of optically-anisotropic layers having the same inclined direction of the dark portions and different tilt angles are provided. Furthermore, the liquid crystal diffraction element according to the embodiment of the present invention may have a configuration in which the optically-anisotropic layer 36b in which the liquid crystal compound 38 is not twisted and aligned is laminated on the three layers shown in FIG. 17. In addition to the above-described configurations, various configurations can be used in the liquid crystal diffraction element according to the embodiment of the present invention.

In the liquid crystal diffraction element 18 according to the embodiment of the present invention, the optically-anisotropic layer 36 is formed of a liquid crystal composition containing a rod-like liquid crystal compound or a disk-like liquid crystal compound, the liquid crystal compound 38 has the liquid crystal alignment pattern in which the liquid crystal compound 38 is aligned as described above, and the optically-anisotropic layer 36 has a region where the liquid crystal compound 38 has a tilt angle and a region where the tilt angle of the liquid crystal compound 38 varies in the plane.

Such a liquid crystal diffraction element can be produced by forming, on the substrate 32, the alignment film 34 having an alignment pattern corresponding to the above-described liquid crystal alignment pattern, applying the liquid crystal composition onto the alignment film 34, and curing the liquid crystal composition to form the optically-anisotropic layer 36 consisting of a cured layer of the liquid crystal composition.

The liquid crystal composition for forming the optically-anisotropic layer 36 contains a rod-like liquid crystal compound or a disk-like liquid crystal compound, and may further contain other components such as a leveling agent, an alignment control agent, a polymerization initiator, and an alignment assistant.

In addition, it is sufficient that the optically-anisotropic layer 36 has a structure in which the alignment state of the liquid crystal compound is maintained. Typically, the above-described structure is preferably a structure in which a polymerizable liquid crystal compound is brought into a predetermined alignment state of liquid crystal phase and is polymerized and cured by ultraviolet irradiation, heating, and the like to form a layer without fluidity, and simultaneously, the layer changes to a state that an external field or an external force does not cause a change in alignment.

In the optically-anisotropic layer 36, the liquid crystal compound may not exhibit liquid crystallinity. For example, the polymerizable liquid crystal compound may lose its liquid crystallinity by increasing its molecular weight by a curing reaction.

Examples of a material used for forming the optically-anisotropic layer 36 include a liquid crystal composition containing a liquid crystal compound. It is preferable that the liquid crystal compound is a polymerizable liquid crystal compound. The polymerizable liquid crystal compound may be a rod-like liquid crystal compound or a disk-like liquid crystal compound.

The polymerizable liquid crystal compound is obtained by introducing a polymerizable group into the liquid crystal compound. Examples of the polymerizable group include an unsaturated polymerizable group, an epoxy group, and an aziridinyl group; and an unsaturated polymerizable group is preferable, and an ethylenically unsaturated polymerizable group is more preferable. The polymerizable group can be introduced into the molecule of the liquid crystal compound by various methods. The number of polymerizable groups in the polymerizable liquid crystal compound is preferably 1 to 6 and more preferably 1 to 3.

An addition amount of the polymerizable liquid crystal compound in the liquid crystal composition is preferably 75% to 99.9% by mass, more preferably 80% to 99% by mass, and still more preferably 85% to 98% by mass with respect to the mass of solid contents (mass excluding a solvent) of the liquid crystal composition.

Two or more kinds of polymerizable liquid crystal compounds may be used in combination. In a case where two or more kinds of polymerizable liquid crystal compounds are used in combination, an alignment temperature can be decreased.

In addition, it is preferable that the optically-anisotropic layer 36 has a wide range for the wavelength of incident light, and is formed of a liquid crystal material having a reverse birefringence index dispersion.

### —Rod-Like Liquid Crystal Compound—

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. In addition to the above-described low-molecular-weight liquid crystal molecules, a high-molecular-weight liquid crystal molecular can also be used.

In the optically-anisotropic layer 36, it is preferable that the alignment of the rod-like liquid crystal compound is fixed by polymerization; and examples of the polymerizable rod-like liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/022586A, WO95/024455A, WO97/000600A, WO98/023580A, WO98/052905A, JP1989-272551A (JP-H1-272551A), JP1994-016616A (JP-H6-016616A), JP1995-110469A (JP-H7-110469A), JP1999-080081A (JP-H11-080081A), and JP2001-064627A. Furthermore, as the rod-like liquid crystal compound, for example, compounds described in JP1999-513019A (JP-H11-513019A) and JP2007-279688A can also be preferably used.

### —Disk-Like Liquid Crystal Compound—

As the disk-like liquid crystal compound, for example, compounds described in JP2007-108732A, JP2010-244038A, and the like can be preferably used.

In a case where the disk-like liquid crystal compound is used in the liquid crystal layer, the liquid crystal compound 38 rises in the thickness direction in the liquid crystal layer, and the optical axis 38A derived from the liquid crystal compound is defined as an axis perpendicular to a disc plane, that is, a so-called fast axis.

As described above, the liquid crystal diffraction element 18 includes the substrate 32, the alignment film 34, and the above-described optically-anisotropic layer 36.

As the substrate 32 constituting the liquid crystal diffraction element 18, various sheet-like materials can be used as long as they can support the alignment film 34 and the optically-anisotropic layer 36 described below.

As the substrate 32, a transparent support is preferable; and examples thereof include a polyacrylic resin film such as polymethyl methacrylate, a cellulose-based resin film such as cellulose triacetate, a cycloolefin polymer-based film, polyethylene terephthalate (PET), polycarbonate, and polyvinyl chloride. Examples of a commercially available product of the cycloolefin polymer-based film include “ARTON” (trade name) manufactured by JSR Corporation and “ZEONOR” (trade name) manufactured by Nippon Zeon Corporation. The support is not limited to a flexible film and may be a non-flexible substrate such as a glass substrate.

The alignment film 34 is formed on the surface of the substrate 32.

The liquid crystal alignment pattern in the optically-anisotropic layer 36 follows the alignment pattern formed on the alignment film 34. Accordingly, the same alignment pattern as the liquid crystal alignment pattern in the optically-anisotropic layer 36 is formed in the alignment film 34 for forming the liquid crystal layer having the liquid crystal alignment pattern.

The alignment film 34 having the alignment pattern can be formed, for example, by forming a coating film containing a compound having a photo-aligned group, drying the coating film, and exposing the coating film with an exposure device 80 described later.

Preferable examples of the compound having a photo-aligned group, that is, a photo-alignment material used in a photo-alignment film include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking ester, a cinnamate compound, or a chalcone compound is suitability used.

In this way, the coating film serving as the alignment film 34 (photo-alignment film) for forming the optically-anisotropic layer 36 is exposed to form an alignment pattern corresponding to the concentric circular liquid crystal alignment pattern in which the optical axis changes while continuously rotating in a radial shape.

Here, before the concentric circular liquid crystal alignment pattern is exposed, the alignment film 34 can be irradiated with unpolarized light while changing the irradiation amount and the irradiation angle, thereby forming the alignment film 34 in which the liquid crystal compound in the optically-anisotropic layer 36 is tilt-aligned. Specifically, as the irradiation amount of the unpolarized light increases and the irradiation angle with respect to the surface increases (that is, as the polar angle decreases), the tilt angle of the liquid crystal compound 38 in the optically-anisotropic layer 36 can be increased.

For example, the unpolarized light is incident into the alignment film 34 such that an incidence angle gradually decreases and an irradiation amount gradually increases from the center of the alignment film 34 toward the outer direction, with the normal direction of the alignment film 34 being 0° (polar angle: 0°) and the plane direction of the alignment film 34 being 90° (polar angle: 90°). That is, in the liquid crystal diffraction element which is the liquid crystal lens shown in FIG. 1, the unpolarized light is incident into the alignment film 34 such that the incidence angle gradually decreases and the irradiation amount gradually increases from the optical axis of the lens toward the outer direction of the radial direction (concentric circle).

As a result, the alignment film 34 can be formed in which the liquid crystal compound 38 is tilt-aligned such that the tilt angle of the liquid crystal compound 38 gradually increases from the center portion toward the inner side and the outer side as shown in FIG. 3, without the tilt angle of the liquid crystal compound 38 in the center portion.

The irradiation of the alignment film 34 with the unpolarized light is performed in a concentric circular shape. As a result, the alignment film 34 can be formed in which the liquid crystal compound 38 is tilt-aligned such that the tilt angle of the liquid crystal compound 38 gradually increases from the center portion toward the inner side and the outer side corresponding to the concentric circular liquid crystal alignment pattern shown in FIG. 1, without the tilt angle of the liquid crystal compound 38 in the center portion.

In this way, after the alignment film 34 is exposed to tilt-align the liquid crystal compound 38, the alignment film 34 is exposed to form the alignment pattern corresponding to the concentric circular liquid crystal alignment pattern in which the optical axis changes while continuously rotating in a radial shape.

FIG. 18 conceptually shows an example of an exposure device in which the coating film serving as the alignment film 34 (photo-alignment film) for forming the optically-anisotropic layer 36 is exposed to form an alignment pattern corresponding to the concentric circular liquid crystal alignment pattern in which the optical axis changes while continuously rotating in a radial shape.

An exposure device 80 shown in FIG. 18 includes a light source 84 which includes a laser 82, a polarization beam splitter 86 which splits a laser light M emitted from the laser 82 into an S-polarized light MS and a P-polarized light MP, a mirror 90A which is disposed on an optical path of the P-polarized light MP and a mirror 90B which is disposed on an optical path of the S-polarized light MS, a lens 92 which is disposed on the optical path of the S-polarized light MS, a polarization beam splitter 94, and a λ/4 plate 96.

The P-polarized light MP which is split by the polarization beam splitter 86 is reflected from the mirror 90A to be incident into the polarization beam splitter 94. On the other hand, the S-polarized light MS which is split by the polarization beam splitter 86 is reflected from the mirror 90B and is focused by the lens 92 to be incident into the polarization beam splitter 94.

The P polarized light MP and the S polarized light MS are combined by the polarization beam splitter 94, are converted into dextrorotatory circularly polarized light and levorotatory circularly polarized light by the λ/4 plate 96 depending on the polarization direction, and are incident into the alignment film 34 on the substrate 32.

Due to interference between the dextrorotatory circularly polarized light and the levorotatory circularly polarized light, the polarization state of light with which the alignment film 34 is irradiated periodically changes according to interference fringes. An intersecting angle between dextrorotatory circularly polarized light and levorotatory circularly polarized light changes from the inside to the outside of the concentric circle, so that an exposure pattern in which the pitch changes from the inner side toward the outer side can be obtained. Accordingly, a radial (concentric) alignment pattern in which the alignment states periodically change is obtained in the alignment film 34.

In the exposure device 80, the single period Λ of the liquid crystal alignment pattern in which the optical axis of the liquid crystal compound 38 continuously rotates by 180° in the one direction can be controlled by changing a focal power of the lens 92, the focal length of the lens 92, the distance between the lens 92 and the alignment film 34, and the like.

In addition, by adjusting the focal power of the lens 92 (F number of the lens 92), the length of the single period of the liquid crystal alignment pattern in which the optical axis continuously rotates in the one direction can be changed.

Specifically, the length of the single period in the liquid crystal alignment pattern in which the optical axis continuously rotates in the one direction can be changed depending on a light spread angle at which light is spread by the lens 92 due to interference with parallel light. More specifically, in a case where the focal power of the lens 92 is decreased, the light is close to the parallel light, so that the length A of the single period in the liquid crystal alignment pattern is gradually decreased from the inner side toward the outer side. Conversely, in a case where the focal power of the lens 92 is stronger, the length A of the single period in the liquid crystal alignment pattern rapidly decreases from the inner side toward the outer side.

That is, by adjusting the refractive index of the lens 92, the refractive index of the liquid crystal diffraction element 18 (optically-anisotropic layer 36) can be adjusted to act as a concave lens or a convex lens depending on the turning direction of the incident circularly polarized light.

The optically-anisotropic layer 36 having the above-described concentric circular liquid crystal alignment pattern, the region where the liquid crystal compound 38 has the tilt angle, and the region where the tilt angle of the liquid crystal compound 38 varies in the plane can be formed by applying the liquid crystal composition for forming the optically-anisotropic layer 36 to the exposed alignment film 34 formed as described above, drying the liquid crystal composition, and curing the liquid crystal composition by ultraviolet irradiation or the like as necessary. As a result, the liquid crystal diffraction element 18 as shown in FIGS. 1 and 2 can be produced.

In the above-described liquid crystal diffraction element according to the embodiment of the present invention, the optically-anisotropic layer has the concentric circular liquid crystal alignment pattern as shown in FIG. 1, but the present invention is not limited thereto.

For example, in the liquid crystal diffraction element according to the embodiment of the present invention, the optically-anisotropic layer may have a linear liquid crystal alignment pattern in one direction (arrow A direction) as shown in FIG. 6. Such a linear liquid crystal alignment pattern can be formed by exposing the alignment film using a known method such as a method with an exposure device described in FIG. 10 of JP7200383B.

In addition, in a case where the single period of the linear liquid crystal alignment pattern in one direction (arrow A direction) changes in a plane, the liquid crystal diffraction element acts as, for example, a cylindrical lens which focuses light in a linear manner or a divergent lens which diverges light in two opposite directions.

### Second Embodiment

Another example (second embodiment) of the liquid crystal diffraction element according to the present invention includes an optically-anisotropic layer formed of a liquid crystal composition containing a liquid crystal compound, in which the optically-anisotropic layer has a liquid crystal alignment pattern in which an orientation of an optical axis derived from the liquid crystal compound changes while continuously rotating in at least one in-plane direction, in a case where a retardation is measured from a normal direction of a main surface of the optically-anisotropic layer and from a direction inclined with respect to a normal line, in the optically-anisotropic layer, a region where a direction in which the retardation reaches an extreme value is inclined with respect to the normal direction is provided, and in a plane of the optically-anisotropic layer, a region where a direction of the optically-anisotropic layer in which the retardation reaches an extreme value varies is provided. In the following description, the direction in which the retardation reaches an extreme value is also referred to as “direction D_{R}” for convenience.

Regarding the configuration of the liquid crystal diffraction element according to the present embodiment, the drawings used in the description of the liquid crystal diffraction element according to the first embodiment can be referred to, and the present embodiment will be described with reference to the above-described drawings as necessary.

The present inventors have found that, in a case where the liquid crystal diffraction element is in the above-described second embodiment, the decrease in diffraction efficiency can be further suppressed even in a region where the single period Λ of the liquid crystal alignment pattern is short, particularly, a region where the single period Λ of the liquid crystal alignment pattern is 1 μm or less.

In the plane of the optically-anisotropic layer, it is preferable that an angle θ2 between the direction D_{R} in which the retardation reaches an extreme value and the normal line of the main surface of the optically-anisotropic layer gradually changes.

Among these, it is more preferable that the angle θ2 gradually changes as the single period Λ in the liquid crystal alignment pattern of the optically-anisotropic layer gradually changes in the plane of the optically-anisotropic layer; and it is still more preferable that the angle θ2 increases as the single period Λ in the liquid crystal alignment pattern of the optically-anisotropic layer decreases.

In a case where the optically-anisotropic layer has the above-described configuration, the diffraction efficiency can be improved even in the region where the single period in the liquid crystal diffraction element is short, and the amount of light reflected from the incident light can be further improved.

The above-described gradual change of the angle θ2 may be a continuous change or a stepwise change in which regions having the same tilt angle are provided, and a region where the angle θ2 continuously changes and a region where the angle θ2 changes stepwise may be mixed.

On at least a part of the optically-anisotropic layer in the plane, a region where the direction D_{R} is the normal direction of the main surface may be provided.

In addition, the optically-anisotropic layer may have a configuration in which the direction D_{R} is inclined in the entire in-plane region.

A method of measuring the direction D_{R} in the optically-anisotropic layer of the liquid crystal diffraction element will be described.

The direction D_{R} in which the above-described retardation Re reaches an extreme value (minimal value or maximal value) can be detected by measuring the retardation Re of the optically-anisotropic layer by allowing measurement light to be incident from the normal direction of the main surface of the optically-anisotropic layer, and further measuring the retardation Re of the optically-anisotropic layer by sequentially changing the incidence direction (the incidence angle with respect to the normal line) of the measurement light. The above-described retardation means a retardation in a plane orthogonal to a direction in which the measurement light is incident.

The above-described measurement of the retardation Re is performed by calculating a slow axis direction by the above-described method using a polarization phase difference analyzer Axoscan (manufactured by Axometrics, Inc.), and then sequentially inclining the measurement light in a plane (slow axis plane) which is perpendicular to the main surface of the optically-anisotropic layer and includes the slow axis of the optically-anisotropic layer and in a plane (fast axis plane) which is perpendicular to the main surface of the optically-anisotropic layer and includes a direction (fast axis) perpendicular to the slow axis of the optically-anisotropic layer in the plane.

The measurement light to be used for measuring the above-described retardation Re is preferably light having a wavelength outside the wavelength range of the light diffracted by the optically-anisotropic layer; and for example, infrared light which is invisible light is preferable.

In the optically-anisotropic layer according to the present embodiment, the fast axis plane usually coincides with a direction in which the optical axis continuously rotates in the in-plane direction, and the slow axis direction coincides with a direction orthogonal to the direction in which the optical axis continuously rotates in the plane.

A method for manufacturing the optically-anisotropic layer of the liquid crystal diffraction element according to the present embodiment, which has the region where the direction D_{R} is inclined with respect to the normal direction and the region where the direction D_{R} varies in the plane, is not particularly limited; and examples thereof include a method of tilt-aligning the liquid crystal compound contained in the optically-anisotropic layer in the region where the direction D_{R} is inclined with respect to the normal direction. The direction D_{R} in which the retardation Re reaches an extreme value in the in-plane region can be adjusted depending on the tilt alignment angle (tilt angle) and direction of the liquid crystal compound.

The method for manufacturing the optically-anisotropic layer in which the liquid crystal compound is tilt-aligned and the method of adjusting the tilt angle and the like are as described in the first embodiment.

In the present embodiment, it is preferable that the optically-anisotropic layer has a region where the liquid crystal compound has a tilt angle with respect to the surface of the optically-anisotropic layer on at least one surface of the optically-anisotropic layer, and the optically-anisotropic layer has a region where the tilt angle of the liquid crystal compound with respect to the surface of the optically-anisotropic layer varies in a plane.

In a case where the optically-anisotropic layer has the above-described regions in the plane, the decrease in diffraction efficiency can be further suppressed even in a region where the single period in the liquid crystal diffraction element is short.

In the optically-anisotropic layer, it is preferable that the tilt angle of the liquid crystal compound with respect to the surface of the optically-anisotropic layer gradually changes in the plane of the optically-anisotropic layer; and it is more preferable that the tilt angle of the liquid crystal compound gradually changes as the single period Λ in the liquid crystal alignment pattern of the optically-anisotropic layer gradually changes in the plane of the optically-anisotropic layer.

Among these, in the liquid crystal diffraction element (optically-anisotropic layer), in consideration of the fact that the diffraction efficiency decreases as the single period Λ in the liquid crystal alignment pattern decreases, it is still more preferable that the tilt angle of the liquid crystal compound increases as the single period Λ in the liquid crystal alignment pattern of the optically-anisotropic layer decreases.

However, the liquid crystal diffraction element according to the present embodiment is not limited to the above-described aspects. The tilt angle of the liquid crystal compound in the optically-anisotropic layer may be constant in the plane, or may decrease in conjunction with the decrease in single period Λ in the liquid crystal alignment pattern, or the tilt angle of the liquid crystal compound may not change in conjunction with the change in single period Λ in the liquid crystal alignment pattern.

Here, in the liquid crystal diffraction element according to the present embodiment, it is preferable that an angle of the direction of the optically-anisotropic layer in which the retardation reaches an extreme value from the normal direction of the main surface of the optically-anisotropic layer is close to the angle between the traveling direction of light in the optically-anisotropic layer and the normal line of the optically-anisotropic layer.

Specifically, in the optical device according to the embodiment of the present invention, including the liquid crystal diffraction element according to the present embodiment and a light source, in a case where light is incident at an angle θin from the light source, it is preferable that, in a case where a refractive index of the optically-anisotropic layer is indicated by nG and an emission angle of light emitted from the liquid crystal diffraction element into the air is indicated by θm, an angle θP [°] of the direction of the optically-anisotropic layer in which the retardation reaches an extreme value from the normal direction of the main surface of the optically-anisotropic layer is ±15° of an angle θG [°] calculated by the following expression.

$$Sin θ G = Sin θ m / nG$$

$$θ P {[}^{∘} ] = θG \pm 15 {[}^{∘} ] , that is ,$$

$$θ G {[}^{∘} ] - {15}^{∘} \leq θ P {[}^{∘} ] \leq θ G {[}^{∘} ] + 1 {5}^{o}$$

The liquid crystal diffraction element according to the present embodiment is the same as the liquid crystal diffraction element according to the first embodiment in terms of the formulation of the optically-anisotropic layer containing the liquid crystal compound, the physical properties (optical and physical) of the optically-anisotropic layer, including the tilt angle of the liquid crystal compound, the formation method, and the like, including the suitable aspects thereof.

In addition, members other than the optically-anisotropic layer in the liquid crystal diffraction element according to the present embodiment are the same as those in the liquid crystal diffraction element according to the first embodiment, including the suitable aspects thereof.

Hereinafter, characteristics of the liquid crystal diffraction element according to the embodiment of the present invention will be described without distinction between the first embodiment and the second embodiment.

Furthermore, the liquid crystal diffraction element according to the embodiment of the present invention is also suitable for being used as an optical unit in combination with a circularly polarizing plate.

By combining the liquid crystal diffraction element according to the embodiment of the present invention with the circularly polarizing plate, it is possible to allow desired circularly polarized light to be incident into the liquid crystal diffraction element according to the embodiment of the present invention. In addition, by combining the liquid crystal diffraction element according to the embodiment of the present invention with the circularly polarizing plate, it is also possible to emit the circularly polarized light diffracted by the liquid crystal diffraction element according to the embodiment of the present invention as linearly polarized light.

The circularly polarizing plate is not limited, and various known circularly polarizing plates such as a circularly polarizing plate in which a wave plate (retardation plate) such as a ¼ wavelength plate (λ/4 plate) and a linear polarizer are combined can be used.

The phase difference plate used in the present invention may be a single-layer type composed of one optically-anisotropic layer, or may be a multi-layer type composed of a lamination of two or more optically-anisotropic layers each having a plurality of different slow axes. Examples of the multi-layer type phase difference plate include phase difference plates described in WO2013/137464A, WO2016/158300A, JP2014-209219A, JP2014-209220A, WO2014/157079A, JP2019-215416A, WO2019/160044A, JP2014-026266A, WO2022/030266A, WO2021/132624A, WO2021/033631A, WO2022/045185A, WO2022/045185A, WO2019/160016A, and WO2020/100813A; but the multi-layer type phase difference plate is not limited to these.

In the configuration in which the liquid crystal diffraction element according to the embodiment of the present invention and the circularly polarizing plate are used in combination, another optical element which is provided downstream of the circularly polarizing plate may also be used in combination.

For example, a retardation plate may be disposed downstream of the circularly polarizing plate. Specifically, a configuration in which linearly polarized light transmitted through the circularly polarizing plate (the retardation plate and the linearly polarizing plate are disposed in this order) is converted into circularly polarized light, elliptically polarized light, or linearly polarized light having a different polarization direction by the retardation plate disposed downstream of the circularly polarizing plate can also be preferably adopted.

In addition, instead of the retardation plate, a depolarization layer which depolarizes the polarization state of light in at least a part of a wavelength range may be used. As the depolarization layer, for example, a high retardation film (having an in-plane retardation of 3,000 nm or more) or a light scattering layer can be used. By controlling the polarization state of the light emitted from the circularly polarizing plate, the polarization state can be adjusted depending on applications.

In another example, an optical element which is provided downstream of the circularly polarizing plate to deflect light may be used. For example, by disposing the optical element such as a lens which deflects light downstream of the circularly polarizing plate, a traveling direction of the light emitted from the circularly polarizing plate can be changed. By controlling the deflection direction of the light emitted from the circularly polarizing plate, the emission direction of light can be adjusted depending on applications.

### <Adhesive Layer (Pressure-Sensitive Adhesive Layer) and Adhesive>

The liquid crystal diffraction element may include an adhesive layer for adhesion of the respective layers. In the present specification, the “adhesive” is used as a concept including “pressure-sensitive adhesive”.

Examples of the adhesive include a water-soluble adhesive, an ultraviolet curable adhesive, an emulsion type adhesive, a latex type adhesive, a mastic adhesive, a multi-layered adhesive, a paste-like adhesive, a foaming adhesive, a supported film adhesive, a thermoplastic adhesive, a hot-melt adhesive, a thermally solidified adhesive, a thermally activated adhesive, a heat-seal adhesive, a thermosetting adhesive, a contact type adhesive, a pressure-sensitive adhesive, a polymerizable adhesive, a solvent type adhesive, a solvent-activated adhesive, and a ceramic adhesive.

Specific examples thereof include a boron compound aqueous solution, a curable adhesive of an epoxy compound not having an aromatic ring in a molecule, as described in JP2004-245925A; an active energy ray-curable adhesive having a molar absorption coefficient of 400 or more at a wavelength of 360 to 450 nm and containing a photopolymerization initiator and an ultraviolet curable compound as essential components, as described in JP2008-174667A; and an active energy ray-curable adhesive containing (a) a (meth)acrylic compound having two or more (meth)acryloyl groups in a molecule, (b) a (meth)acrylic compound having a hydroxyl group and only one polymerizable double bond in a molecule, and (c) a phenol ethylene oxide modified acrylate or a nonyl phenol ethylene oxide modified acrylate with respect to 100 parts by mass of the total amount of the (meth)acrylic compounds, as described in JP2008-174667A. These adhesives may be used alone or may be used in combination as necessary.

In the liquid crystal diffraction element, from the viewpoint of reducing unnecessary reflection, it is preferable that a difference in refractive index between the adhesive layer and a layer adjacent thereto is small. Specifically, the difference in refractive index with the adjacent layer is preferably 0.05 or less and more preferably 0.01 or less. A method of adjusting the refractive index of the adhesive layer is not particularly limited, and for example, a known method such as a method of adding fine particles of zirconia, silica, acryl, acrylic-styrene, melamine, or the like, a method of adjusting the refractive index by a resin, and a method described in JP1999-223712A (JP-H11-223712A) can be used.

In addition, in a case where the adjacent layer has refractive index anisotropy in a plane, it is preferable that the difference in refractive index with the adjacent layer is 0.05 or less in all in-plane directions. Therefore, the adhesive layer may have refractive index anisotropy in a plane.

In a case where a difference in refractive index between adhesion interfaces is large, an interface reflectivity can be reduced by generating a refractive index distribution in the thickness direction of the adhesive layer. Examples of a method of generating the refractive index distribution in the thickness direction include a method of providing a plurality of adhesive layers, a method of mixing interfaces between a plurality of adhesive layers provided, and a method of controlling an uneven distribution state of a material in the adhesive layer to generate the refractive index distribution.

In addition, the adhesive layer can be provided on one member or both members to be bonded using any method such as application, vapor deposition, or transfer, and from the viewpoint of increasing an adhesion strength, a post-treatment such as a heating treatment and ultraviolet irradiation can be performed according to the type of the adhesive.

A thickness of the adhesive layer can be optionally adjusted, but it is preferably 20 μm or less and more preferably 0.1 μm or less. Examples of a method of forming the adhesive layer having a thickness of 0.1 μm or less include a method of vapor-depositing a ceramic adhesive such as silicon oxide (SiOₓ layer) on the bonding surface.

For the bonding surface of the bonding member, before the bonding, for example, a surface reforming treatment such as a plasma treatment, a corona treatment, and a saponification treatment can be performed, and a primer layer can be applied. In addition, in a case where a plurality of bonding surfaces are present, the kind and thickness of the adhesive layer can be adjusted for each of the bonding surfaces.

### <Cutting of Liquid Crystal Diffraction Element>

The produced liquid crystal diffraction element can be cut into a predetermined size.

A method of cutting the liquid crystal diffraction element is not particularly limited, and for example, various known methods such as a method of physically cutting the liquid crystal diffraction element using a blade such as a Thomson blade and a method of cutting the liquid crystal diffraction element by laser irradiation can be used. In a case where the laser is used, it is preferable to select a pulse width (nanoseconds, picoseconds, or femtoseconds) and a wavelength in consideration of cuttability, damage to a material, and the like. In addition, after processing the liquid crystal diffraction element in a predetermined shape, for example, edge surface polishing may be performed.

From the viewpoint of improving workability during cutting and suppressing dust generation, the liquid crystal diffraction element can also be cut in a state in which a peelable protective film is attached. In addition, for example, by cutting the liquid crystal diffraction element while observing the liquid crystal alignment pattern by a method described in JP2004-141889A, a cutting position can be optionally determined. In this case, in order to make the liquid crystal alignment pattern visible, the liquid crystal alignment pattern can also be observed through a polarizing plate, a phase difference film, or the like. In addition, in a case where a plurality of optical elements are provided on one substrate, it is preferable that the plurality of optical elements are cut at the same time.

### <Other Treatments>

From the viewpoint of accurately installing the liquid crystal diffraction element in the device, improving the accuracy of the axis and the cutting position during cutting, and the like, a mark having any shape can be provided as necessary. The kind of the mark can be freely selected, and a method of physically forming the mark using a laser, an ink jet method, or the like, a method of partially changing the alignment state of the liquid crystal, a method of forming a region which is partially decolored or colored, or the like can be selected.

In addition, in order to protect the liquid crystal layer, optionally, a protective layer (a gas barrier layer, a layer for blocking moisture or the like, an ultraviolet absorbing layer, a scratch resistance layer, or the like) can be provided. The protective layer can be directly formed on the liquid crystal layer, or may be provided through a pressure sensitive adhesive layer, another optical film, or the like. An antireflection layer may be provided for the purpose of reducing the reflectivity of the surface. Examples of the antireflection layer include a low reflection (LR) layer, an anti reflective (AR) layer, and a moth eye layer. Various protective layers can be appropriately selected from known protective layers. In a case where the gas barrier layer is provided, polyvinyl alcohol is preferable. The polyvinyl alcohol can also serve as a polarizer. In addition, the ultraviolet absorbing layer is a layer containing an ultraviolet absorber, and as the ultraviolet absorber, from the viewpoint of excellent absorbing capability of ultraviolet light having a wavelength of 370 nm or less and excellent display properties, an ultraviolet absorber having small absorption of visible light having a wavelength of 400 nm or more is preferably used. As the ultraviolet absorber, one kind may be used alone or two or more kinds may be used in combination. Examples thereof include ultraviolet absorbers described in JP2001-072782A and JP2002-543265A. Specific examples of the ultraviolet absorber include an oxybenzophenone-based compound, a benzotriazole-based compound, a salicylic acid ester-based compound, a benzophenone-based compound, a cyanoacrylate-based compound, and a nickel complex salt-based compound.

That is, the liquid crystal diffraction element according to the embodiment of the present invention can be used as an optical unit in combination with various members.

In addition, the liquid crystal diffraction element according to the embodiment of the present invention and the optical unit including the liquid crystal diffraction element according to the embodiment of the present invention can be used as an optical module in combination with various members.

Furthermore, the liquid crystal diffraction element according to the embodiment of the present invention, the optical unit (optical element) including the liquid crystal diffraction element according to the embodiment of the present invention, and the optical module including the liquid crystal diffraction element according to the embodiment of the present invention can be used in various optical devices.

Examples of the optical device including the liquid crystal diffraction element according to the embodiment of the present invention include a head mounted display, a virtual reality (VR) display device, a sensor, and a communication device.

### <Combination of Plurality of Liquid Crystal Diffraction Elements>

The liquid crystal diffraction element according to the embodiment of the present invention can be used as a combination of a plurality of liquid crystal diffraction elements.

For example, by combining a plurality of liquid crystal diffraction elements and changing the polarization states incident into the liquid crystal diffraction elements, as described in Optics Express, Vol. 28, No. 16/3, August 2020, collecting properties/diverging properties of emitted light can be switched between a plurality of combinations.

By combining the plurality of liquid crystal diffraction elements, display corresponding to fovea centralis (foveated display) can be performed in a head mounted display (HMD) such as augmented reality (AR) glasses and VR glasses.

<Combination with Phase Modulation Element>

A configuration in which the liquid crystal diffraction element according to the embodiment of the present invention is used in combination with a phase modulation element can also be preferably used.

For example, by using a switchable half waveplate (switchable λ/2 plate) which can modulate a phase difference with a voltage, as described in U.S. Ser. No. 10/379,419B, and the liquid crystal diffraction element according to the embodiment of the present invention (used as a passive element) in combination, a focus tunable lens having a high diffraction efficiency irrespective of light incidence positions in a plane of the element can be realized. In addition, by using plural sets of the phase modulation element and the liquid crystal diffraction element in combination, the number of adjustable focal lengths can be increased.

By using such a focus-variable lens in an HMD such as AR glasses and VR glasses, a focal position of a display image of the HMD can be optionally changed.

<Combination with Lens>

A configuration in which the liquid crystal diffraction element according to the embodiment of the present invention is used in combination with another lens element can also be preferably used.

For example, by using the liquid crystal diffraction element according to the embodiment of the present invention in combination with a Fresnel lens described in SID 2020 DIGEST, 40-4, pp. 579 to 582, chromatic aberration of the lens can be improved with a high diffraction efficiency irrespective of light incidence positions in a plane of the element. The lens to be used in combination is not particularly limited, and a combination with a refractive index lens, a pancake lens described in U.S. Pat. No. 3,443,858A, Optics Express, Vol. 29, No 4/15, February 2021, pp. 6011 to 6014, or the like can also be suitably used.

By using an optical system including the lens and the liquid crystal diffraction element in combination for AR glasses or VR glasses, color shift (chromatic aberration of the lens) of a display image of the HMD can be improved.

<Combination with Light Guide Plate>

A configuration in which the liquid crystal diffraction element according to the embodiment of the present invention is used in combination with a light guide plate can also be preferably used.

For example, in a combination of a light guide plate and a lens described in Proc. of SPIE Vol. 11062, Digital Optical Technologies 2019, 110620J (16 Jul. 2019), by using the liquid crystal diffraction element according to the embodiment of the present invention as the lens, a focal position of a display image emitted from the light guide plate can be changed.

By using in combination with the light guide plate in this way, the focal position of a display image of the HMD such as AR glasses and VR glasses can be adjusted. For use in AR glasses, by using the liquid crystal diffraction elements according to the embodiment of the present invention as positive and negative lenses between which a light guide plate is interposed as described in Proc. of SPIE Vol. 11062, Digital Optical Technologies 2019, 110620J (16 Jul. 2019), both of an actual scene and a display image output from the light guide plate can be observed without distortion.

<Combination with Image Display Apparatus>

The liquid crystal diffraction element according to the embodiment of the present invention can be preferably used in combination with an image display apparatus.

For example, by using the liquid crystal diffraction element (used as a diffractive deflection film) and an image display apparatus described in Crystals 2021, 11, 107 in combination, a brightness distribution of emitted light from the image display apparatus can be adjusted.

By using the image display unit combined with the image display apparatus, a brightness distribution of the HMD such as AR glasses and VR glasses can be suitably adjusted.

In addition, in the above description, an example in which the amount of the zero-order light is reduced by combining the liquid crystal diffraction element according to the embodiment of the present invention with the circularly polarizing plate has been described, but for example, the amount of the zero-order light can also be reduced by combining a polarization optical unit such as a pancake lens with an image device unit in which the image display apparatus and the liquid crystal diffraction element according to the embodiment of the present invention are combined.

<Combination with Image Display Apparatus Using Polarization Optical Unit>

The liquid crystal diffraction element according to the embodiment of the present invention can be preferably used in combination with an image display apparatus using a polarization optical unit.

For example, by using the liquid crystal diffraction element according to the embodiment of the present invention as a holographic lens of an HMD using an image display apparatus and a polarization optical unit (Polarization-based optical folding, Pancake optics) as described in ACM Trans. Graph., Vol. 39, No. 4, Article 67, it is possible to reduce ghosting of a thin and lightweight HMD.

<Combination with Beam Steering>

A combination of the liquid crystal diffraction element according to the embodiment of the present invention with a light deflection element (beam steering) can also be preferably used.

For example, by using the liquid crystal diffraction element according to the embodiment of the present invention as a diffraction element of a light deflection element described in WO2019/189675A, a deflection angle of emitted light can be increased with a high diffraction efficiency.

By using in combination with the light deflection element (beam steering), a light irradiation angle of a distance-measuring sensor such as light detection and ranging (LiDAR) can be suitably widened.

Hereinbefore, the liquid crystal diffraction element and the optical device according to the embodiments of the present invention have been described in detail, but the present invention is not limited to the above-described examples, and various improvements or modifications may be made within a range not departing from the scope of the present invention.

### EXAMPLES

Hereinafter, the characteristics of the present invention will be described in detail by Examples.

Materials, chemicals, used amounts, material amounts, ratios, treatment details, treatment procedures, and the like shown in the following examples can be appropriately changed within a range not departing from the scope of the present invention. Therefore, the scope of the present invention should not be construed as being limited to the following specific examples.

### Comparative Example 1

### <Production of Liquid Crystal Diffraction Element>

### (Support)

A glass substrate was used as a support.

### (Formation of Alignment Film)

The following coating liquid for forming an alignment film was applied onto the support by spin coating. The support on which the coating film of the alignment film-forming coating liquid was formed was dried using a hot plate at 60° C. for 60 seconds. As a result, an alignment film was formed.

Alignment film-forming coating liquid

| | |
|---|---|
| Material A for photo-alignment | 1.00 part by mass |
| Water | 16.00 parts by mass |
| Butoxyethanol | 42.00 parts by mass |
| Propylene glycol monomethyl ether | 42.00 parts by mass |

-Material A for photo-alignment-

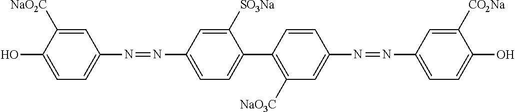

### (Exposure of Alignment Film)

The alignment film was exposed using the exposure device shown in FIG. 18 to form an alignment film P-1 having a concentric circular alignment pattern.

In the exposure device, a laser which emits laser beam having a wavelength (355 nm) was used as the laser. An exposure amount of the interference light was set to 1,000 mJ/cm².

### (Formation of Optically-Anisotropic Layer)

As a liquid crystal composition forming an optically-anisotropic layer, the following composition A-1 was prepared.

Composition A-1

| | |
|---|---|
| Liquid crystal compound L-1 | 10.00 parts by mass |
| Liquid crystal compound L-2 | 90.00 parts by mass |
| Polymerization initiator (manufactured by BASF, Irgacure OXE 01) | 1.00 part by mass |
| Surfactant F1 | 0.30 parts by mass |
| Methyl ethyl ketone | 550.00 parts by mass |
| Cyclopentanone | 550.00 parts by mass |

Liquid crystal compound L-1 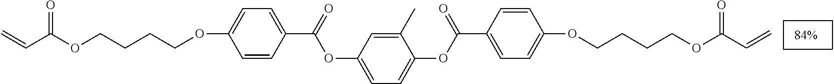 [SMILES: C=CC(=O)OCCCCOc1ccc(C(=O)Oc2ccc(OC(=O)c3ccc(OCCCCOC(=O)C=C)cc3)c(C)c2)cc1] 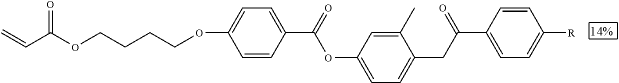 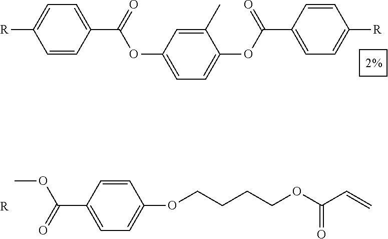
Liquid crystal compound L-2 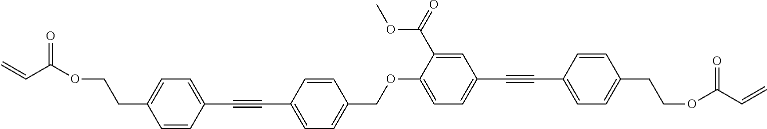 [SMILES: C=CC(=O)OCCc1ccc(C#Cc2ccc(COc3ccc(C#Cc4ccc(CCOC(=O)C=C)cc4)cc3C(=O)OC)cc2)cc1]
Surfactant F1

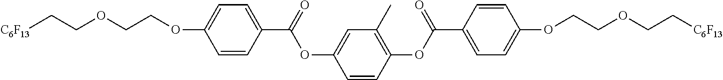

An optically-anisotropic layer was formed by applying the composition A-1 to the alignment film P-1 in multiple layers. The application in multiple layers refers to repetition of processes including producing a first liquid crystal immobilized layer by applying the first layer-forming composition A-1 onto the alignment film, heating the composition A-1, and irradiating the composition A-1 with ultraviolet light for curing; and producing a second or subsequent liquid crystal immobilized layer by applying the second or subsequent layer-forming composition A-1 onto the formed liquid crystal immobilized layer, heating the composition A-1, and irradiating the composition A-1 with ultraviolet light for curing as described above.

In a case where the optically-anisotropic layer was formed by applying multiple layers, even in a case where the total thickness of the optically-anisotropic layer was large, the alignment direction of the alignment film was transferred from the lower surface to the upper surface of the optically-anisotropic layer.

Regarding a first layer, the above-described composition A-1 was applied onto the alignment film P-1 to form a coating film, the coating film was heated to 80° C. on a hot plate, the coating film was irradiated with ultraviolet rays having a wavelength of 365 nm at an irradiation amount of 300 mJ/cm² using a high-pressure mercury lamp in a nitrogen atmosphere, thereby fixing the alignment of the liquid crystal compound.

Regarding the second or subsequent layer, the composition was applied onto the liquid crystal immobilized layer, and heated, and cured with ultraviolet rays under the same conditions as described above to produce a liquid crystal immobilized layer.

In this way, by repeating the application multiple times until the total thickness reached a desired film thickness, an optically-anisotropic layer was formed, and a liquid crystal diffraction element was produced.

A birefringence index Δn of the cured layer of the liquid crystal composition A-1 was obtained by applying the liquid crystal composition A-1 onto a support with an alignment film for retardation measurement, which was prepared separately, aligning a director of the liquid crystal compound to be parallel to the base material, irradiating the liquid crystal composition A-1 with ultraviolet rays for immobilization to obtain a liquid crystal immobilized layer (cured layer), and measuring a retardation value and a film thickness of the liquid crystal immobilized layer. Δn could be calculated by dividing the retardation value by the film thickness.

The retardation value was measured by measuring a desired wavelength using Axoscan (manufactured by Axometrics, inc.) and measuring the film thickness using a SEM.

In the optically-anisotropic layer, Δn₅₅₀×thickness (Re(550)) of the liquid crystals was finally 275 nm, and it was confirmed using a polarization microscope that periodic alignment occurred on the surface. Hereinafter, unless specified otherwise, “Δn₅₅₀×d” and the like were measured in the same manner as described above.

In the optically-anisotropic layer, a twisted angle of the liquid crystal compound in the thickness direction was 0°.

In addition, in the liquid crystal alignment pattern of the optically-anisotropic layer, regarding a single period over which the optical axis of the liquid crystal compound rotated by 180°, a single period of a portion at a distance of 2.5 mm from the center was 5.3 m; a single period of a portion at a distance of 20 mm from the center was 0.8 m; and the single period decreased toward the outer direction.

Furthermore, in the optically-anisotropic layer, a tilt angle of the liquid crystal compound was 0° at a distance of 2.5 mm from the center, and a tilt angle of the liquid crystal compound was also 0° at a distance of 20 mm from the center.

Using “Axoscan” manufactured by Axometrics, Inc., a retardation in the in-plane direction parallel to the one direction of the liquid crystal alignment pattern was measured by changing the incidence angle of the measurement light. A measurement wavelength was set to 940 nm. In addition, the incidence angle of the measurement light was in a range of −70° to 70°. As a result, a measurement angle at which the direction in which the retardation reached an extreme value was an angle with respect to the normal direction of the main surface of the optically-anisotropic layer was obtained. In the optically-anisotropic layer, the retardation was measured at a distance of 2.5 mm from the center and a distance of 20 mm from the center. In the optically-anisotropic layer, the direction in which the retardation reached the extreme value at the position 2.5 mm away from the center and the position 20 mm away from the center was the normal direction of the main surface of the optically-anisotropic layer.

### Example 1

### <Production of Liquid Crystal Diffraction Element>

### (Formation of Alignment Film)

An alignment film was formed on the support in the same manner as in Comparative Example 1.

### (Exposure of Alignment Film)

The formed alignment film was irradiated with unpolarized ultraviolet rays having a wavelength of 365 nm using an LED-UV exposure machine.

In this case, the coating film was irradiated with ultraviolet rays while changing the irradiation amount and the irradiation angle of the ultraviolet rays in a plane. Specifically, the alignment film was irradiated while changing the irradiation amount in the plane such that the irradiation amount increased from the center toward the outer side. In addition, in a case where the normal direction of the glass substrate was regarded as 0° and the plane direction of the glass substrate was regarded as 90°, the alignment film was irradiated while changing the irradiation angle in the plane such that the irradiation angle decreased from the center toward the outer side.

The irradiation of the alignment film with the unpolarized ultraviolet rays was carried out in a concentric circular shape.

Next, the alignment film was exposed in the same manner as in Comparative Example 1 using the exposure device shown in FIG. 18 to form an alignment film P-2 having a concentric circular alignment pattern.

### (Formation of Optically-Anisotropic Layer)

A liquid crystal composition forming an optically-anisotropic layer was prepared by changing the surfactant F1 in the composition A-1 of Comparative Example 1 to the following surfactant F2 (0.03 parts by mass) and the following surfactant F3 (0.20 parts by mass).

An optically-anisotropic layer was formed using the prepared liquid crystal composition in the same manner as in Comparative Example 1. In a case of laminating the optically-anisotropic layers, multi-layer coating was carried out by spin-coating the formed optically-anisotropic layer with methyl ethyl ketone, drying the layer, and forming the subsequent optically-anisotropic layer.

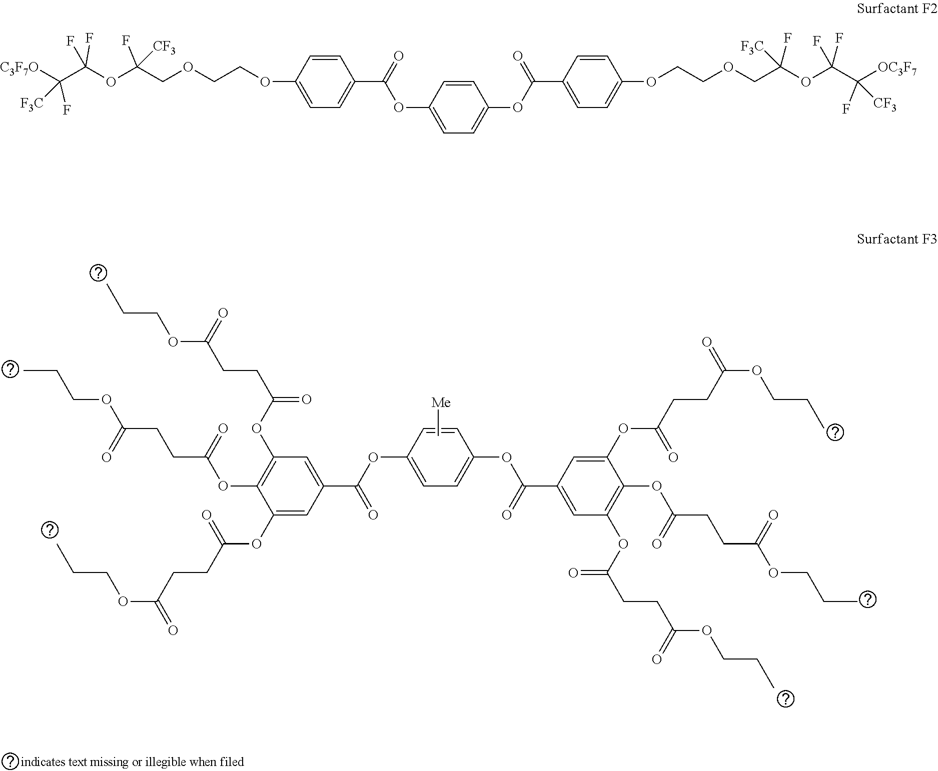

In the optically-anisotropic layer, Δn₅₅₀×thickness (Re(550)) of the liquid crystals was finally 275 nm, and it was confirmed using a polarization microscope that periodic alignment occurred on the surface.

In the optically-anisotropic layer, a twisted angle of the liquid crystal compound in the thickness direction was 0°.

In addition, in the liquid crystal alignment pattern of the optically-anisotropic layer, regarding a single period over which the optical axis of the liquid crystal compound rotated by 180°, a single period of a portion at a distance of 2.5 mm from the center was 5.3 m; a single period of a portion at a distance of 20 mm from the center was 0.8 m; and the single period decreased toward the outer direction.

Furthermore, in the optically-anisotropic layer, a tilt angle of the liquid crystal compound was 2° at a distance of 2.5 mm from the center, and a tilt angle of the liquid crystal compound was 23° at a distance of 20 mm from the center.

Using “Axoscan” in the same manner as in Comparative Example 1, a retardation in the in-plane direction parallel to the one direction of the liquid crystal alignment pattern was measured by changing the incidence angle of the measurement light. In the optically-anisotropic layer, the direction in which the retardation reached the extreme value at the position 2.5 mm away from the center was the normal direction of the main surface of the optically-anisotropic layer. In addition, the direction in which the retardation reached the extreme value at the position 20 mm away from the center was inclined from the normal direction of the main surface of the optically-anisotropic layer. In the optically-anisotropic layer of Example 1, the tilt angles of the directions in which the retardation reached the extreme value at the position 2.5 mm away from the center (the single period over which the optical axis of the liquid crystal compound rotated by 180° was 5.3 μm) and at the position 20 mm away from the center (the single period over which the optical axis of the liquid crystal compound rotated by 180° was 0.8 μm) were different, and the tilt angle was larger at the position 20 mm away from the center.

### Comparative Example 2

### <Production of Liquid Crystal Diffraction Element>

### (Formation of Alignment Film)

An alignment film P-1 was formed in the same manner as in Comparative Example 1.

### (Formation of Optically-Anisotropic Layer)

As a liquid crystal composition forming a first optically-anisotropic layer, the following composition B-1 was prepared.

Composition B-1

| | | |
|---|---|---|
| Liquid crystal compound L-1 | 10.00 | parts by mass |
| Liquid crystal compound L-2 | 90.00 | parts by mass |
| Chiral agent C1 | 0.69 | parts by mass |
| Polymerization initiator | 1.00 | part by mass |
| (manufactured by BASF, Irgacure OXE 01) | | |
| Surfactant F1 | 0.30 | parts by mass |
| Methyl ethyl ketone | 550.00 | parts by mass |
| Cyclopentanone | 550.00 | parts by mass |

A first optically-anisotropic layer was formed of the composition B-1 by the same method for the first optically-anisotropic layer of Comparative Example 1, except that the film thickness of the optically-anisotropic layer was adjusted.

### Chiral Agent C1

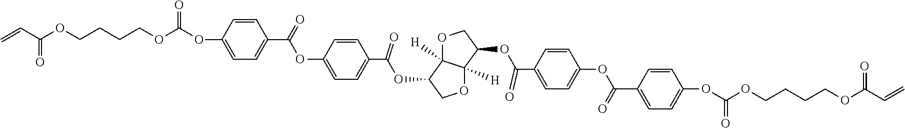 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

In the first optically-anisotropic layer, Δn₅₅₀×thickness (Re(550)) of the liquid crystals was finally 150 nm, and it was confirmed using a polarization microscope that periodic alignment occurred on the surface.

In the optically-anisotropic layer, a twisted angle of the liquid crystal compound in the thickness direction was 83°.

In addition, in the liquid crystal alignment pattern of the optically-anisotropic layer, regarding a single period over which the optical axis of the liquid crystal compound rotated by 180°, a single period of a portion at a distance of 2.5 mm from the center was 5.3 μm; a single period of a portion at a distance of 20 mm from the center was 0.8 μm; and the single period decreased toward the outer direction.

Furthermore, in the optically-anisotropic layer, a tilt angle of the liquid crystal compound was 0° at a distance of 2.5 mm from the center, and a tilt angle of the liquid crystal compound was also 0° at a distance of 20 mm from the center.

As a liquid crystal composition forming a second optically-anisotropic layer, the following composition B-2 was prepared.

Composition B-2

| | | |
|---|---|---|
| Liquid crystal compound L-1 | 10.00 | parts by mass |
| Liquid crystal compound L-2 | 90.00 | parts by mass |
| Chiral agent C1 | 0.03 | parts by mass |
| Polymerization initiator (manufactured | 1.00 | part by mass |
| by BASF, Irgacure OXE 01) | | |
| Surfactant F1 | 0.30 | parts by mass |
| Methyl ethyl ketone | 550.00 | parts by mass |
| Cyclopentanone | 550.00 | parts by mass |

A second optically-anisotropic layer was formed of the composition B-2 by the same method for the first optically-anisotropic layer, except that the film thickness of the optically-anisotropic layer was adjusted.

In the second optically-anisotropic layer, Δn₅₅₀×thickness (Re(550)) of the liquid crystals was finally 335 nm, and it was confirmed using a polarization microscope that periodic alignment occurred on the surface.

In the optically-anisotropic layer, a twisted angle of the liquid crystal compound in the thickness direction was 8°.

In addition, in the liquid crystal alignment pattern of the optically-anisotropic layer, regarding a single period over which the optical axis of the liquid crystal compound rotated by 180°, a single period of a portion at a distance of 2.5 mm from the center was 5.3 m; a single period of a portion at a distance of 20 mm from the center was 0.8 m; and the single period decreased toward the outer direction.

Furthermore, in the optically-anisotropic layer, a tilt angle of the liquid crystal compound was 0° at a distance of 2.5 mm from the center, and a tilt angle of the liquid crystal compound was also 0° at a distance of 20 mm from the center.

As a liquid crystal composition forming a third optically-anisotropic layer, the following composition B-3 was prepared.

Composition B-3

| | |
|---|---|
| Liquid crystal compound L-1 | 10.00 parts by mass |
| Liquid crystal compound L-2 | 90.00 parts by mass |
| Chiral agent C2 | 0.60 parts by mass |
| Polymerization initiator (manufactured by BASF, Irgacure OXE 01) | 1.00 part by mass |
| Surfactant F1 | 0.30 parts by mass |
| Methyl ethyl ketone | 550.00 parts by mass |
| Cyclopentanone | 550.00 parts by mass |

Chiral agent C2

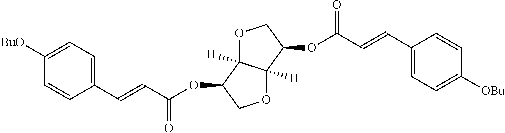

A third optically-anisotropic layer was formed of the composition B-3 by the same method for the first optically-anisotropic layer, except that the film thickness of the optically-anisotropic layer was adjusted, thereby producing a liquid crystal diffraction element.

In the third optically-anisotropic layer, Δn₅₅₀×thickness (Re(550)) of the liquid crystals was finally 170 nm, and it was confirmed using a polarization microscope that periodic alignment occurred on the surface.

In the optically-anisotropic layer, a twisted angle of the liquid crystal compound in the thickness direction was −78°.

In addition, in the liquid crystal alignment pattern of the optically-anisotropic layer, regarding a single period over which the optical axis of the liquid crystal compound rotated by 180°, a single period of a portion at a distance of 2.5 mm from the center was 5.3 m; a single period of a portion at a distance of 20 mm from the center was 0.8 m; and the single period decreased toward the outer direction.

Furthermore, in the optically-anisotropic layer, a tilt angle of the liquid crystal compound was 0° at a distance of 2.5 mm from the center, and a tilt angle of the liquid crystal compound was also 0° at a distance of 20 mm from the center.

Using “Axoscan” in the same manner as in Comparative Example 1, a retardation in the in-plane direction parallel to the one direction of the liquid crystal alignment pattern was measured by changing the incidence angle of the measurement light. In the optically-anisotropic layer, the direction in which the retardation reached the extreme value at the position 2.5 mm away from the center and the position 20 mm away from the center was the normal direction of the main surface of the optically-anisotropic layer. [0152][Example 2]

### <Production of Liquid Crystal Diffraction Element>

### (Formation of Alignment Film)

An alignment film P-2 was formed in the same manner as in Example 1.

That is, in the alignment film P-2, the exposure device shown in FIG. 18 was used for carrying out the exposure in which the irradiation angle and the irradiation amount of the unpolarized ultraviolet rays were in a concentric circular shape from the center toward the outer side of the alignment film.

### (Formation of Optically-Anisotropic Layer)

A liquid crystal composition forming a first optically-anisotropic layer was prepared by changing the surfactant F1 in the composition B-1 of Comparative Example 2 to the surfactant F2 (0.03 parts by mass) and the surfactant F3 (0.20 parts by mass).

A first optically-anisotropic layer was formed using the prepared liquid crystal composition in the same manner as in Comparative Example 2. In a case of laminating the optically-anisotropic layers, multi-layer coating was carried out by spin-coating the formed optically-anisotropic layer with methyl ethyl ketone, drying the layer, and forming the subsequent optically-anisotropic layer.

In the first optically-anisotropic layer, Δn₅₅₀×thickness (Re(550)) of the liquid crystals was finally 150 nm, and it was confirmed using a polarization microscope that periodic alignment occurred on the surface.

In the optically-anisotropic layer, a twisted angle of the liquid crystal compound in the thickness direction was 83°.

In addition, in the liquid crystal alignment pattern of the optically-anisotropic layer, regarding a single period over which the optical axis of the liquid crystal compound rotated by 180°, a single period of a portion at a distance of 2.5 mm from the center was 5.3 μm; a single period of a portion at a distance of 20 mm from the center was 0.8 μm; and the single period decreased toward the outer direction.

Furthermore, in the optically-anisotropic layer, a tilt angle of the liquid crystal compound was 2° at a distance of 2.5 mm from the center, and a tilt angle of the liquid crystal compound was 23° at a distance of 20 mm from the center.

A liquid crystal composition forming a second optically-anisotropic layer was prepared by changing the surfactant F1 in the composition B-2 of Comparative Example 2 to the surfactant F2 (0.03 parts by mass) and the surfactant F3 (0.20 parts by mass).

A second optically-anisotropic layer was formed using the prepared liquid crystal composition in the same manner as in Comparative Example 2. In a case of laminating the second optically-anisotropic layer, multi-layer coating was carried out by spin-coating the formed optically-anisotropic layer with methyl ethyl ketone, drying the layer, and forming the subsequent optically-anisotropic layer.

In the second optically-anisotropic layer, Δn₅₅₀×thickness (Re(550)) of the liquid crystals was finally 335 nm, and it was confirmed using a polarization microscope that periodic alignment occurred on the surface.

In the optically-anisotropic layer, a twisted angle of the liquid crystal compound in the thickness direction was 8°.

In addition, in the liquid crystal alignment pattern of the optically-anisotropic layer, regarding a single period over which the optical axis of the liquid crystal compound rotated by 180°, a single period of a portion at a distance of 2.5 mm from the center was 5.3 μm; a single period of a portion at a distance of 20 mm from the center was 0.8 μm; and the single period decreased toward the outer direction.

Furthermore, in the optically-anisotropic layer, a tilt angle of the liquid crystal compound was 2° at a distance of 2.5 mm from the center, and a tilt angle of the liquid crystal compound was 23° at a distance of 20 mm from the center.

A liquid crystal composition forming a third optically-anisotropic layer was prepared by changing the surfactant F1 in the composition B-3 of Comparative Example 2 to the surfactant F2 (0.03 parts by mass) and the surfactant F3 (0.20 parts by mass).

A third optically-anisotropic layer was formed using the prepared liquid crystal composition in the same manner as in Comparative Example 2, thereby producing a liquid crystal diffraction element. In a case of laminating the third optically-anisotropic layer, multi-layer coating was carried out by spin-coating the formed optically-anisotropic layer with methyl ethyl ketone, drying the layer, and forming the subsequent optically-anisotropic layer.

In the third optically-anisotropic layer, Δn₅₅₀×thickness (Re(550)) of the liquid crystals was finally 170 nm, and it was confirmed using a polarization microscope that periodic alignment occurred on the surface.

In the optically-anisotropic layer, a twisted angle of the liquid crystal compound in the thickness direction was −78°.

In addition, in the liquid crystal alignment pattern of the optically-anisotropic layer, regarding a single period over which the optical axis of the liquid crystal compound rotated by 180°, a single period of a portion at a distance of 2.5 mm from the center was 5.3 μm; a single period of a portion at a distance of 20 mm from the center was 0.8 μm; and the single period decreased toward the outer direction.

Furthermore, in the optically-anisotropic layer, a tilt angle of the liquid crystal compound was 2° at a distance of 2.5 mm from the center, and a tilt angle of the liquid crystal compound was 23° at a distance of 20 mm from the center.

Using “Axoscan” in the same manner as in Comparative Example 1, a retardation in the in-plane direction parallel to the one direction of the liquid crystal alignment pattern was measured by changing the incidence angle of the measurement light. In the optically-anisotropic layer, the direction in which the retardation reached the extreme value at the position 2.5 mm away from the center was the normal direction of the main surface of the optically-anisotropic layer. In addition, the direction in which the retardation reached the extreme value at the position 20 mm away from the center was inclined from the normal direction of the main surface of the optically-anisotropic layer. In the optically-anisotropic layer of Example 2, the tilt angles of the directions in which the retardation reached the extreme value at the position 2.5 mm away from the center (the single period over which the optical axis of the liquid crystal compound rotated by 180° was 5.3 μm) and at the position 20 mm away from the center (the single period over which the optical axis of the liquid crystal compound rotated by 180° was 0.8 μm) were different, and the tilt angle was larger at the position 20 mm away from the center.

In addition, in a case where cross sections of the liquid crystal diffraction elements of Comparative Example 2 and Example 2 were observed with a SEM, cross-sectional SEM images were observed in which the second optically-anisotropic layer having a dark portion extending approximately in the thickness direction as shown in FIG. 17 was sandwiched between the first optically-anisotropic layer and the third optically-anisotropic layer having opposite inclination directions of the dark portion.

### [Evaluation]

In a case where light was incident into the produced optical element from the front (direction with an angle of 0° with respect to the normal line), intensity of emitted light was evaluated.

Specifically, each of laser light components having output central wavelengths of 450 nm, 532 nm, and 650 nm was irradiated to be vertically incident into the produced liquid crystal diffraction element from a light source. The laser light was made to be circularly polarized by being perpendicularly incident into a circularly polarizing plate corresponding to the wavelength of the laser light, and then the circularly polarized light was incident into the produced liquid crystal diffraction element.

Among the emitted light from the liquid crystal diffraction element, the intensities of diffracted light (first-order light) diffracted in a desired direction from the liquid crystal diffraction element and zero-order light (emitted in the same one direction as the incidence light) emitted in another direction were measured with a photodetector.

The intensity of diffracted light of the first-order light was evaluated by the following expression.

Intensity of diffracted light=First-order light/(First-order light+Zero-order light)

In the liquid crystal diffraction elements produced in Comparative Example 1 and Example 1, the intensities of diffracted light of the first-order light at a wavelength of 532 nm at the position of 2.5 mm away from the center were substantially the same.

On the other hand, at the position of 20 mm away from the center, the liquid crystal diffraction element according to Example 1 was improved in the intensity of diffracted light of the first-order light at a wavelength of 532 nm as compared with the liquid crystal diffraction element according to Comparative Example 1.

In the liquid crystal diffraction elements produced in Comparative Example 2 and Example 2, the intensities of diffracted light of the first-order light at a wavelength of 532 nm at the position of 2.5 mm away from the center were substantially the same.

On the other hand, at the position of 20 mm away from the center, the liquid crystal diffraction element according to Example 2 was improved in the intensity of diffracted light of the first-order light at a wavelength of 532 nm as compared with the liquid crystal diffraction element according to Comparative Example 2.

In addition, the average values of the intensities of diffracted light of the first-order light at the wavelengths of 450 nm, 532 nm, and 650 nm were substantially the same at the position of 2.5 mm away from the center in Comparative Example 2 and Example 2; and the average value of the intensities of diffracted light of the liquid crystal diffraction element of Example 2 was larger than that of the liquid crystal diffraction element of Comparative Example 2 at the position of 20 mm away from the center.

Furthermore, the average value of the intensities of diffracted light of the first-order light at the wavelengths of 450 nm, 532 nm, and 650 nm was larger at any of the position of 2.5 mm away from the center and the position of 20 mm away from the center in the liquid crystal diffraction element according to Example 2 having a plurality of optically-anisotropic layers having different tilt angles of the dark portions in the cross-sectional SEM image, as compared with the liquid crystal diffraction element according to Example 1 having one optically-anisotropic layer.

### Comparative Example 3

### <Production of Liquid Crystal Diffraction Element>

### (Formation of Alignment Film)

An alignment film was formed in the same manner as in Comparative Example 1.

### (Exposure of Alignment Film)

Next, the alignment film was exposed in the same manner as in Comparative Example 1 using the exposure device shown in FIG. 18 to form an alignment film P-3 having a concentric circular alignment pattern.

However, in the present example, the length of the single period in the concentric circular alignment pattern was changed by adjusting the focal length of the lens 92.

### (Formation of Optically-Anisotropic Layer)

An optically-anisotropic layer was formed by the same method as that of Comparative Example 1.

In the optically-anisotropic layer, Δn₅₅₀×thickness (Re(550)) of the liquid crystals was finally 275 nm, and it was confirmed using a polarization microscope that periodic alignment occurred on the surface.

In the optically-anisotropic layer, a twisted angle of the liquid crystal compound in the thickness direction was 0°.

In addition, in the liquid crystal alignment pattern of the optically-anisotropic layer, regarding a single period over which the optical axis of the liquid crystal compound rotated by 180°, a single period of a portion at a distance of 5 mm from the center was 80 μm; a single period of a portion at a distance of 20 mm from the center was 20 μm; and the single period decreased toward the outer direction.

Furthermore, in the optically-anisotropic layer, a tilt angle of the liquid crystal compound was 0° at a distance of 5 mm from the center, and a tilt angle of the liquid crystal compound was also 0° at a distance of 20 mm from the center.

Using “Axoscan” manufactured by Axometrics, Inc., a retardation in the in-plane direction parallel to the one direction of the liquid crystal alignment pattern was measured by changing the incidence angle of the measurement light. A measurement wavelength was set to 940 nm. In addition, the incidence angle of the measurement light was in a range of −70° to 70°. As a result, a measurement angle at which the direction in which the retardation reached an extreme value was an angle with respect to the normal direction of the main surface of the optically-anisotropic layer was obtained. In the optically-anisotropic layer, the retardation was measured at a distance of 5 mm from the center and a distance of 20 mm from the center. In the optically-anisotropic layer, the direction in which the retardation reached the extreme value at the position 5 mm away from the center and the position 20 mm away from the center was the normal direction of the main surface of the optically-anisotropic layer.

### Example 3

### <Production of Liquid Crystal Diffraction Element>

### (Formation of Alignment Film)

An alignment film was formed on the support in the same manner as in Comparative Example 1.

### (Exposure of Alignment Film)

An alignment film P-4 was formed in the same manner as in Example 1.

That is, in the alignment film P-4, the exposure device shown in FIG. 18 was used for carrying out the exposure in which the irradiation angle and the irradiation amount of the unpolarized ultraviolet rays were in a concentric circular shape from the center toward the outer side of the alignment film.

However, in the present example, the irradiation angle and the irradiation amount of light were changed in the irradiation of the unpolarized ultraviolet rays prior to the exposure by the exposure device shown in FIG. 18. In addition, as in Comparative Example 3, in the present example, the length of the single period in the concentric circular alignment pattern was changed by adjusting the focal length of the lens 92.

### (Formation of Optically-Anisotropic Layer)

An optically-anisotropic layer was formed by the same method as that of Example 1.

In the optically-anisotropic layer, Δn₅₅₀×thickness (Re(550)) of the liquid crystals was finally 275 nm, and it was confirmed using a polarization microscope that periodic alignment occurred on the surface.

In the optically-anisotropic layer, a twisted angle of the liquid crystal compound in the thickness direction was 0°.

In the liquid crystal alignment pattern of the optically-anisotropic layer, regarding a single period over which the optical axis of the liquid crystal compound rotated by 180°, a single period of a portion at a distance of 5 mm from the center was 80 μm; a single period of a portion at a distance of 20 mm from the center was 20 μm; and the single period decreased toward the outer direction.

Furthermore, in the optically-anisotropic layer, a tilt angle of the liquid crystal compound was 0° at a distance of 5 mm from the center, and a tilt angle of the liquid crystal compound was 26° at a distance of 20 mm from the center.

Using “Axoscan” in the same manner as in Comparative Example 3, a retardation in the in-plane direction parallel to the one direction of the liquid crystal alignment pattern was measured by changing the incidence angle of the measurement light. In the optically-anisotropic layer, the direction in which the retardation reached the extreme value at the position 5 mm away from the center was the normal direction of the main surface of the optically-anisotropic layer. In addition, the direction in which the retardation reached the extreme value at the position 20 mm away from the center was inclined from the normal direction of the main surface of the optically-anisotropic layer. In the optically-anisotropic layer of Example 3, the tilt angles of the directions in which the retardation reached the extreme value at the position 5 mm away from the center (the single period over which the optical axis of the liquid crystal compound rotated by 180° was 80 m) and at the position 20 mm away from the center (the single period over which the optical axis of the liquid crystal compound rotated by 180° was 20 m) were different, and the tilt angle was larger at the position 20 mm away from the center.

### Comparative Example 4

### <Production of Liquid Crystal Diffraction Element>

### (Formation of Alignment Film)

An alignment film P-3 was formed in the same manner as in Comparative Example 3.

### (Formation of Optically-Anisotropic Layer)

As a liquid crystal composition forming a first optically-anisotropic layer, the following composition C-1 was prepared.

Composition C-1

| | | |
|---|---|---|
| Liquid crystal compound L-1 | 10.00 | parts by mass |
| Liquid crystal compound L-2 | 90.00 | parts by mass |
| Chiral agent C1 | 0.62 | parts by mass |
| Polymerization initiator (manufactured | 1.00 | part by mass |
| by BASF, Irgacure OXE 01) | | |
| Surfactant F1 | 0.30 | parts by mass |
| Methyl ethyl ketone | 550.00 | parts by mass |
| Cyclopentanone | 550.00 | parts by mass |

A first optically-anisotropic layer was formed of the composition C-1 by the same method for the first optically-anisotropic layer of Comparative Example 2, except that the film thickness of the optically-anisotropic layer was adjusted.

In the first optically-anisotropic layer, Δn₅₅₀×thickness (Re(550)) of the liquid crystals was finally 160 nm, and it was confirmed using a polarization microscope that periodic alignment occurred on the surface.

In the optically-anisotropic layer, a twisted angle of the liquid crystal compound in the thickness direction was 80°.

In addition, in the liquid crystal alignment pattern of the optically-anisotropic layer, regarding a single period over which the optical axis of the liquid crystal compound rotated by 180°, a single period of a portion at a distance of 5 mm from the center was 80 m; a single period of a portion at a distance of 20 mm from the center was 20 m; and the single period decreased toward the outer direction.

Furthermore, in the optically-anisotropic layer, a tilt angle of the liquid crystal compound was 0° at a distance of 5 mm from the center, and a tilt angle of the liquid crystal compound was also 0° at a distance of 20 mm from the center.

As a liquid crystal composition forming a second optically-anisotropic layer, the following composition C-2 was prepared.

Composition C-2

| | | |
|---|---|---|
| Liquid crystal compound L-1 | 10.00 | parts by mass |
| Liquid crystal compound L-2 | 90.00 | parts by mass |
| Polymerization initiator (manufactured | 1.00 | part by mass |
| by BASF, Irgacure OXE01) | | |
| Surfactant F1 | 0.30 | parts by mass |
| Methyl ethyl ketone | 550.00 | parts by mass |
| Cyclopentanone | 550.00 | parts by mass |

A second optically-anisotropic layer was formed of the composition C-2 by the same method for the first optically-anisotropic layer, except that the film thickness of the optically-anisotropic layer was adjusted.

In the second optically-anisotropic layer, Δn₅₅₀×thickness (Re(550)) of the liquid crystals was finally 330 nm, and it was confirmed using a polarization microscope that periodic alignment occurred on the surface.

In the optically-anisotropic layer, a twisted angle of the liquid crystal compound in the thickness direction was 0°.

In addition, in the liquid crystal alignment pattern of the optically-anisotropic layer, regarding a single period over which the optical axis of the liquid crystal compound rotated by 180°, a single period of a portion at a distance of 5 mm from the center was 80 μm; a single period of a portion at a distance of 20 mm from the center was 20 μm; and the single period decreased toward the outer direction.

Furthermore, in the optically-anisotropic layer, a tilt angle of the liquid crystal compound was 0° at a distance of 5 mm from the center, and a tilt angle of the liquid crystal compound was also 0° at a distance of 20 mm from the center.

As a liquid crystal composition forming a third optically-anisotropic layer, the following composition C-3 was prepared.

Composition C-3

| | | |
|---|---|---|
| Liquid crystal compound L-1 | 10.00 | parts by mass |
| Liquid crystal compound L-2 | 90.00 | parts by mass |
| Chiral agent C2 | 0.66 | parts by mass |
| Polymerization initiator (manufactured | 1.00 | part by mass |
| by BASF, Irgacure OXE01) | | |
| Surfactant F1 | 0.30 | parts by mass |
| Methyl ethyl ketone | 550.00 | parts by mass |
| Cyclopentanone | 550.00 | parts by mass |

A third optically-anisotropic layer was formed of the composition C-3 by the same method for the first optically-anisotropic layer, except that the film thickness of the optically-anisotropic layer was adjusted, thereby producing a liquid crystal diffraction element.

In the third optically-anisotropic layer, Δn₅₅₀×thickness (Re(550)) of the liquid crystals was finally 160 nm, and it was confirmed using a polarization microscope that periodic alignment occurred on the surface.

In the optically-anisotropic layer, a twisted angle of the liquid crystal compound in the thickness direction was −80°.

In addition, in the liquid crystal alignment pattern of the optically-anisotropic layer, regarding a single period over which the optical axis of the liquid crystal compound rotated by 180°, a single period of a portion at a distance of 5 mm from the center was 80 m; a single period of a portion at a distance of 20 mm from the center was 20 m; and the single period decreased toward the outer direction.

Furthermore, in the optically-anisotropic layer, a tilt angle of the liquid crystal compound was 0° at a distance of 5 mm from the center, and a tilt angle of the liquid crystal compound was also 0° at a distance of 20 mm from the center.

Using “Axoscan” in the same manner as in Comparative Example 3, a retardation in the in-plane direction parallel to the one direction of the liquid crystal alignment pattern was measured by changing the incidence angle of the measurement light. In the optically-anisotropic layer, the retardation was measured at a distance of 5 mm from the center and a distance of 20 mm from the center. In the optically-anisotropic layer, the direction in which the retardation reached the extreme value at the position 5 mm away from the center and the position 20 mm away from the center was the normal direction of the main surface of the optically-anisotropic layer.

### Example 4

### <Production of Liquid Crystal Diffraction Element>

### (Formation of Alignment Film)

An alignment film P-4 was formed in the same manner as in Example 3.

That is, in the alignment film P-4, the exposure device shown in FIG. 18 was used for carrying out the exposure in which the irradiation angle and the irradiation amount of the unpolarized ultraviolet rays were in a concentric circular shape from the center toward the outer side of the alignment film.

### (Formation of Optically-Anisotropic Layer)

A liquid crystal composition forming a first optically-anisotropic layer was prepared by changing the surfactant F1 in the composition C-1 of Comparative Example 4 to the surfactant F2 (0.03 parts by mass) and the surfactant F3 (0.20 parts by mass).

A first optically-anisotropic layer was formed using the prepared composition in the same manner as in Comparative Example 4. In a case of laminating the first optically-anisotropic layer, multi-layer coating was carried out by spin-coating the formed optically-anisotropic layer with methyl ethyl ketone, drying the layer, and forming the subsequent optically-anisotropic layer.

In the first optically-anisotropic layer, Δn₅₅₀×thickness (Re(550)) of the liquid crystals was finally 160 nm, and it was confirmed using a polarization microscope that periodic alignment occurred on the surface.

In the optically-anisotropic layer, a twisted angle of the liquid crystal compound in the thickness direction was 80°.

In addition, in the liquid crystal alignment pattern of the optically-anisotropic layer, regarding a single period over which the optical axis of the liquid crystal compound rotated by 180°, a single period of a portion at a distance of 5 mm from the center was 80 μm; a single period of a portion at a distance of 20 mm from the center was 20 μm; and the single period decreased toward the outer direction.

Furthermore, in the optically-anisotropic layer, a tilt angle of the liquid crystal compound was 0° at a distance of 5 mm from the center, and a tilt angle of the liquid crystal compound was 26° at a distance of 20 mm from the center.

A liquid crystal composition forming a second optically-anisotropic layer was prepared by changing the surfactant F1 in the composition C-2 of Comparative Example 4 to the surfactant F2 (0.03 parts by mass) and the surfactant F3 (0.20 parts by mass).

A second optically-anisotropic layer was formed using the prepared composition in the same manner as in Comparative Example 4. In a case of laminating the optically-anisotropic layers, multi-layer coating was carried out by spin-coating the formed optically-anisotropic layer with methyl ethyl ketone, drying the layer, and forming the subsequent optically-anisotropic layer.

In the second optically-anisotropic layer, Δn₅₅₀×thickness (Re(550)) of the liquid crystals was finally 330 nm, and it was confirmed using a polarization microscope that periodic alignment occurred on the surface.

In the optically-anisotropic layer, a twisted angle of the liquid crystal compound in the thickness direction was 0°.

In addition, in the liquid crystal alignment pattern of the optically-anisotropic layer, regarding a single period over which the optical axis of the liquid crystal compound rotated by 180°, a single period of a portion at a distance of 5 mm from the center was 80 μm; a single period of a portion at a distance of 20 mm from the center was 20 μm; and the single period decreased toward the outer direction.

Furthermore, in the optically-anisotropic layer, a tilt angle of the liquid crystal compound was 0° at a distance of 5 mm from the center, and a tilt angle of the liquid crystal compound was 26° at a distance of 20 mm from the center.

A liquid crystal composition forming a third optically-anisotropic layer was prepared by changing the surfactant F1 in the composition C-3 of Comparative Example 4 to the surfactant F2 (0.03 parts by mass) and the surfactant F3 (0.20 parts by mass).

A third optically-anisotropic layer was formed using the prepared composition in the same manner as in Comparative Example 4, thereby producing a liquid crystal diffraction element. In a case of laminating the optically-anisotropic layers, multi-layer coating was carried out by spin-coating the formed optically-anisotropic layer with methyl ethyl ketone, drying the layer, and forming the subsequent optically-anisotropic layer.

In the third optically-anisotropic layer, Δn₅₅₀×thickness (Re(550)) of the liquid crystals was finally 160 nm, and it was confirmed using a polarization microscope that periodic alignment occurred on the surface.

In the optically-anisotropic layer, a twisted angle of the liquid crystal compound in the thickness direction was −80°.

In the liquid crystal alignment pattern of the optically-anisotropic layer, regarding a single period over which the optical axis of the liquid crystal compound rotated by 180°, a single period of a portion at a distance of 5 mm from the center was 80 μm; a single period of a portion at a distance of 20 mm from the center was 20 μm; and the single period decreased toward the outer direction.

Furthermore, in the optically-anisotropic layer, a tilt angle of the liquid crystal compound was 0° at a distance of 5 mm from the center, and a tilt angle of the liquid crystal compound was 26° at a distance of 20 mm from the center.

Using “Axoscan” in the same manner as in Comparative Example 3, a retardation in the in-plane direction parallel to the one direction of the liquid crystal alignment pattern was measured by changing the incidence angle of the measurement light. In the optically-anisotropic layer, the direction in which the retardation reached the extreme value at the position 5 mm away from the center was the normal direction of the main surface of the optically-anisotropic layer. In addition, the direction in which the retardation reached the extreme value at the position 20 mm away from the center was inclined from the normal direction of the main surface of the optically-anisotropic layer. In the optically-anisotropic layer of Example 4, the tilt angles of the directions in which the retardation reached the extreme value at the position 5 mm away from the center (the single period over which the optical axis of the liquid crystal compound rotated by 180° was 80 μm) and at the position 20 mm away from the center (the single period over which the optical axis of the liquid crystal compound rotated by 180° was 20 μm) were different, and the tilt angle was larger at the position 20 mm away from the center.

In addition, in a case where cross sections of the liquid crystal diffraction elements of Comparative Example 4 and Example 4 were observed with a SEM, cross-sectional SEM images were observed in which the second optically-anisotropic having a dark portion extending in the thickness direction as shown in FIG. 17 was sandwiched between the first optically-anisotropic layer and the third optically-anisotropic layer having opposite inclination directions of the dark portion.

### [Evaluation]

The intensity of diffracted light of the first-order light was evaluated in the same manner as in Comparative Example 1 and Example 1, and Comparative Example 2 and Example 2.

However, in the present example, at a distance of 5 mm away from the center of the concentric circular pattern, light was incident into the liquid crystal diffraction element from the front (direction with an angle of 0° with respect to the normal line); and at a distance of 20 mm away from the center, the evaluation was performed with an incidence angle of 45° with respect to the liquid crystal diffraction element.

As described above, the intensity of diffracted light of the first-order light was evaluated by the following expression.

Intensity of diffracted light=First-order light/(First-order light+Zero-order light)

In the liquid crystal diffraction elements produced in Comparative Example 3 and Example 3, the intensities of diffracted light of the first-order light at a wavelength of 532 nm at the position of 5 mm away from the center were substantially the same.

On the other hand, at the position of 20 mm away from the center, the liquid crystal diffraction element according to Example 3 was improved in the intensity of diffracted light of the first-order light at a wavelength of 532 nm as compared with the liquid crystal diffraction element according to Comparative Example 3.

In the liquid crystal diffraction elements produced in Comparative Example 4 and Example 4, the intensities of diffracted light of the first-order light at a wavelength of 532 nm at the position of 5 mm away from the center were substantially the same. On the other hand, at the position of 20 mm away from the center, the liquid crystal diffraction element according to Example 4 was improved in the intensity of diffracted light of the first-order light at a wavelength of 532 nm as compared with the liquid crystal diffraction element according to Comparative Example 4.

In addition, the average values of the intensities of diffracted light of the first-order light at the wavelengths of 450 nm, 532 nm, and 650 nm were substantially the same at the position of 5 mm away from the center in Comparative Example 4 and Example 4; and the average value of the intensities of diffracted light of the liquid crystal diffraction element of Example 4 was larger than that of the liquid crystal diffraction element of Comparative Example 4 at the position of 20 mm away from the center.

Furthermore, the average value of the intensities of diffracted light of the first-order light at the wavelengths of 450 nm, 532 nm, and 650 nm was larger at any of the position of 2.5 mm away from the center and the position of 20 mm away from the center in the liquid crystal diffraction element according to Example 4 having a plurality of optically-anisotropic layers having different tilt angles of the dark portions in the cross-sectional SEM image, as compared with the liquid crystal diffraction element according to Example 3 having one optically-anisotropic layer.

From the above results, the effect of the present invention is clear.

In addition, in the liquid crystal diffraction element according to each of Examples, the relationship between the angle θG, which was calculated from the following expression (1) using the emission angle θm of the first-order light emitted from the liquid crystal diffraction element by emitting light from the light source and the refractive index nG of the optically-anisotropic layer, and the tilt angle θP of the liquid crystal compound was such that the tilt angle θP was in a range of the angle θG±15°.

Sin θG=Sin θm/nG Expression (1)

In addition, in the liquid crystal diffraction element according to each of Examples, the relationship between the angle θG, which was calculated from the above expression (1) using the emission angle θm of the first-order light emitted from the liquid crystal diffraction element by emitting light from the light source and the refractive index nG of the optically-anisotropic layer, and the angle θP of the direction of the optically-anisotropic layer in which the retardation reached an extreme value from the normal direction of the main surface of the optically-anisotropic layer was such that the angle θP was in a range of the angle θG±15°.

The present invention can be suitably used for a head mounted display or the like.

### EXPLANATION OF REFERENCES

18: liquid crystal diffraction element
32: substrate
34: alignment film
36, 36A, 36B, 36C, 36a, 36b, 36c: optically-anisotropic layer
38: liquid crystal compound
38A: optical axis
40: light source
42: bright portion
44: dark portion
80: exposure device
82: laser
84: light source
86, 94: polarization beam splitter
90A, 90B: mirror
92: lens
96: λ/4 plate

What is claimed is:

1. A liquid crystal diffraction element comprising:
an optically-anisotropic layer formed of a liquid crystal composition containing a liquid crystal compound;
wherein the optically-anisotropic layer has a liquid crystal alignment pattern in which an orientation of an optical axis derived from the liquid crystal compound changes while continuously rotating in at least one in-plane direction,
on at least one surface of the optically-anisotropic layer, a region where the liquid crystal compound has a tilt angle with respect to the surface of the optically-anisotropic layer is provided, and
in a plane of the optically-anisotropic layer, a region where the tilt angle of the liquid crystal compound with respect to the surface of the optically-anisotropic layer varies is provided.

2. A liquid crystal diffraction element comprising:
an optically-anisotropic layer formed of a liquid crystal composition containing a liquid crystal compound;
wherein the optically-anisotropic layer has a liquid crystal alignment pattern in which an orientation of an optical axis derived from the liquid crystal compound changes while continuously rotating in at least one in-plane direction,
in a case where a retardation is measured from a normal direction of a main surface of the optically-anisotropic layer and from a direction inclined with respect to a normal line, in the optically-anisotropic layer, a region where a direction in which the retardation reaches an extreme value is inclined with respect to the normal direction is provided, and
in a plane of the optically-anisotropic layer, a region where the direction of the optically-anisotropic layer in which the retardation reaches an extreme value varies is provided.

3. The liquid crystal diffraction element according to claim 1,
wherein, in a case where a length over which the orientation of the optical axis derived from the liquid crystal compound rotates by 180° in a plane is set as a single period, a region where the length of the single period in the liquid crystal alignment pattern varies in the plane is provided.

4. The liquid crystal diffraction element according to claim 3,
wherein the length of the single period in the liquid crystal alignment pattern gradually changes in the one direction, and
the tilt angle of the liquid crystal compound gradually changes in the one direction.

5. The liquid crystal diffraction element according to claim 4,
wherein the tilt angle of the liquid crystal compound increases as the length of the single period in the liquid crystal alignment pattern decreases.

6. The liquid crystal diffraction element according to claim 1,
wherein, in a cross-sectional image obtained by observing a cross section of the optically-anisotropic layer in a thickness direction along the one direction with a scanning electron microscope, the optically-anisotropic layer has a bright portion and a dark portion, extending from one surface to the other surface, and
in the thickness direction, a region where an inclination angle of the dark portion is different from the tilt angle of the liquid crystal compound is provided.

7. The liquid crystal diffraction element according to claim 6,
wherein a plurality of the optically-anisotropic layers having different inclination angles of the dark portions are provided.

8. An optical device comprising:
the liquid crystal diffraction element according to claim 1; and
a light source which causes light to be incident into the liquid crystal diffraction element,
wherein, in a case where an emission angle of a first-order light emitted from the liquid crystal diffraction element is indicated by θm and a refractive index of the optically-anisotropic layer is indicated by nG, a tilt angle θP of the liquid crystal compound is within a range of θG±15° with regard to an angle θG calculated by the following expression,
Sin θG=Sin θm/nG.

9. An optical device comprising:
the liquid crystal diffraction element according to claim 2; and
a light source which causes light to be incident into the liquid crystal diffraction element,
wherein, in a case where an emission angle of a first-order light emitted from the liquid crystal diffraction element is indicated by θm and a refractive index of the optically-anisotropic layer is indicated by nG, an angle θP between the direction of the optically-anisotropic layer in which the retardation reaches an extreme value and the normal direction of the main surface of the optically-anisotropic layer is within a range of θG±15° with regard to an angle θG calculated by the following expression,
$$Sin θG = Sin θm / nG .$$

10. The liquid crystal diffraction element according to claim 2,
wherein, in a case where a length over which the orientation of the optical axis derived from the liquid crystal compound rotates by 180° in a plane is set as a single period, a region where the length of the single period in the liquid crystal alignment pattern varies in the plane is provided.

11. The liquid crystal diffraction element according to claim 10,
wherein the length of the single period in the liquid crystal alignment pattern gradually changes in the one direction, and
the tilt angle of the liquid crystal compound gradually changes in the one direction.

12. The liquid crystal diffraction element according to claim 11,
wherein the tilt angle of the liquid crystal compound increases as the length of the single period in the liquid crystal alignment pattern decreases.

13. The liquid crystal diffraction element according to claim 2,
wherein, in a cross-sectional image obtained by observing a cross section of the optically-anisotropic layer in a thickness direction along the one direction with a scanning electron microscope, the optically-anisotropic layer has a bright portion and a dark portion, extending from one surface to the other surface, and
in the thickness direction, a region where an inclination angle of the dark portion is different from the tilt angle of the liquid crystal compound is provided.

14. The liquid crystal diffraction element according to claim 13,
wherein a plurality of the optically-anisotropic layers having different inclination angles of the dark portions are provided.

15. An optical device comprising:
the liquid crystal diffraction element according to claim 2; and
a light source which causes light to be incident into the liquid crystal diffraction element,
wherein, in a case where an emission angle of a first-order light emitted from the liquid crystal diffraction element is indicated by θm and a refractive index of the optically-anisotropic layer is indicated by nG, a tilt angle θP of the liquid crystal compound is within a range of θG±15° with regard to an angle θG calculated by the following expression,
$$Sin θG = Sin θm / nG .$$

16. An optical device comprising:
the liquid crystal diffraction element according to claim 3; and
a light source which causes light to be incident into the liquid crystal diffraction element,
wherein, in a case where an emission angle of a first-order light emitted from the liquid crystal diffraction element is indicated by θm and a refractive index of the optically-anisotropic layer is indicated by nG, an angle θP between the direction of the optically-anisotropic layer in which the retardation reaches an extreme value and the normal direction of the main surface of the optically-anisotropic layer is within a range of θG±15° with regard to an angle θG calculated b the following expression,
$$Sin θG = Sin θm / nG .$$

17. The liquid crystal diffraction element according to claim 3,
wherein the tilt angle of the liquid crystal compound increases as the length of the single period in the liquid crystal alignment pattern decreases.

18. The liquid crystal diffraction element according to claim 3,
wherein, in a cross-sectional image obtained by observing a cross section of the optically-anisotropic layer in a thickness direction along the one direction with a scanning electron microscope, the optically-anisotropic layer has a bright portion and a dark portion, extending from one surface to the other surface, and
in the thickness direction, a region where an inclination angle of the dark portion is different from the tilt angle of the liquid crystal compound is provided.

19. The liquid crystal diffraction element according to claim 18,
wherein a plurality of the optically-anisotropic layers having different inclination angles of the dark portions are provided.

20. An optical device comprising:
the liquid crystal diffraction element according to claim 3; and
a light source which causes light to be incident into the liquid crystal diffraction element,
wherein, in a case where an emission angle of a first-order light emitted from the liquid crystal diffraction element is indicated by θm and a refractive index of the optically-anisotropic layer is indicated by nG, a tilt angle θP of the liquid crystal compound is within a range of θG±15° with regard to an angle θG calculated by the following expression,
$$Sin θG = Sin θm / nG .$$
